(19) United States
(12) Patent Application Publication
(10) Pub. No.: US 2024/0172200 A1
(43) Pub. Date: May 23, 2024

(54) DIFFERENT CARRIER FREQUENCIES FOR SECONDARY CELL COVERAGE

(71) Applicant: QUALCOMM Incorporated, San Diego, CA (US)

(72) Inventors: Daniel PAZ, Geva Carmel (IL); Michael LEVITSKY, Rehovot (IL); Assaf TOUBOUL, Netanya (IL)

(21) Appl. No.: 18/058,391

(22) Filed: Nov. 23, 2022

(51) Int. Cl. H04W 72/04

(52) U.S. Cl. CPC H04W 72/0453; H04W 72/042

(57) ABSTRACT

Various aspects of the present disclosure generally relate to wireless communication. In some aspects, a user equipment (UE) may receive, via a primary cell (PCell), first configuration information associated with a secondary cell (SCell) indicating a first carrier frequency associated with the SCell, the first carrier frequency being associated with a first coverage area of the SCell. The UE may communicate, via the SCell, a first one or more signals using the first carrier frequency. The UE may receive, via the PCell, second configuration information associated with the SCell indicating a second carrier frequency associated with the SCell based at least in part on a location of the UE changing from the first coverage area to a second coverage area of the SCell. The UE may communicate, via the SCell, a second one or more signals using the second carrier frequency. Numerous other aspects are described.

### FIELD OF THE DISCLOSURE

Aspects of the present disclosure generally relate to wireless communication and to techniques and apparatuses for different carrier frequencies for secondary cell (SCell) coverage.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of carrier aggregation, in accordance with the present disclosure.

FIG. 5 is a diagram illustrating example of a network deployment, in accordance with the present disclosure.

FIG. 6 is a diagram of an example associated with different carrier frequencies for secondary cell coverage, in accordance with the present disclosure.

FIG. 7 is a diagram of an example associated with different carrier frequencies for secondary cell coverage, in accordance with the present disclosure.

FIG. 8 is a diagram illustrating an example process performed, for example, by a UE, in accordance with the present disclosure.

FIG. 9 is a diagram illustrating an example process performed, for example, by a repeater, in accordance with the present disclosure.

FIG. 10 is a diagram illustrating an example process performed, for example, by a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### SUMMARY

Some aspects described herein relate to a user equipment (UE) for wireless communication. The UE may include a memory and one or more processors coupled to the memory. The one or more processors may be configured to receive, from a network node and via a primary cell, first configuration information associated with a secondary cell indicating a first carrier frequency associated with the secondary cell, the first carrier frequency being associated with a first coverage area of the secondary cell. The one or more processors may be configured to communicate, via the secondary cell, a first one or more signals using the first carrier frequency. The one or more processors may be configured to receive, from the network node and via the primary cell, second configuration information associated with the secondary cell indicating a second carrier frequency associated with the secondary cell based at least in part on a location of the UE changing from the first coverage area to a second coverage area of the secondary cell. The one or more processors may be configured to communicate, via the secondary cell, a second one or more signals using the second carrier frequency.

Some aspects described herein relate to a repeater for wireless communication. The repeater may include a memory and one or more processors coupled to the memory. The one or more processors may be configured to receive, from a network node and via a primary cell, configuration information for a secondary cell, the configuration information indicating a first carrier frequency and a second carrier frequency to be used for the secondary cell, the first carrier frequency and the second carrier frequency being included in a frequency band. The one or more processors may be configured to receive, via the first carrier frequency, a first one or more signals associated with the secondary cell. The one or more processors may be configured to transmit, via the second carrier frequency, a second one or more signals, the second one or more signals being associated with an analog repeating operation of the first one or more signals.

Some aspects described herein relate to a network node for wireless communication. The network node may include a memory and one or more processors coupled to the memory. The one or more processors may be configured to transmit first configuration information, for a repeater, associated with a secondary cell, the first configuration information indicating a first carrier frequency and a second carrier frequency to be used for the secondary cell, the first configuration information indicating that the repeater is to use the first carrier frequency for receiving operations and the second carrier frequency for transmitting operations, and the first carrier frequency and the second carrier frequency being included in a frequency band. The one or more processors may be configured to transmit second configuration information, for a UE, associated with the secondary cell, the second configuration information indicating a first operating frequency, from the first carrier frequency or the second carrier frequency, for the secondary cell.

Some aspects described herein relate to a method of wireless communication performed by UE. The method may include receiving, from a network node and via a primary cell, first configuration information associated with a secondary cell indicating a first carrier frequency associated with the secondary cell, the first carrier frequency being associated with a first coverage area of the secondary cell. The method may include communicating, via the secondary cell, a first one or more signals using the first carrier frequency. The method may include receiving, from the network node and via the primary cell, second configuration information associated with the secondary cell indicating a second carrier frequency associated with the secondary cell based at least in part on a location of the UE changing from the first coverage area to a second coverage area of the secondary cell. The method may include communicating, via the secondary cell, a second one or more signals using the second carrier frequency.

Some aspects described herein relate to a method of wireless communication performed by a repeater. The method may include receiving, from a network node and via a primary cell, configuration information for a secondary cell, the configuration information indicating a first carrier frequency and a second carrier frequency to be used for the secondary cell, the first carrier frequency and the second carrier frequency being included in a frequency band. The method may include receiving, via the first carrier frequency, a first one or more signals associated with the secondary cell. The method may include transmitting, via the second carrier frequency, a second one or more signals, the second one or more signals being associated with an analog repeating operation of the first one or more signals.

Some aspects described herein relate to a method of wireless communication performed by a network node. The method may include transmitting first configuration information, for a repeater, associated with a secondary cell, the first configuration information indicating a first carrier frequency and a second carrier frequency to be used for the secondary cell, the first configuration information indicating that the repeater is to use the first carrier frequency for receiving operations and the second carrier frequency for transmitting operations, and the first carrier frequency and the second carrier frequency being included in a frequency band. The method may include transmitting second configuration information, for a UE, associated with the secondary cell, the second configuration information indicating a first operating frequency, from the first carrier frequency or the second carrier frequency, for the secondary cell.

Some aspects described herein relate to a non-transitory computer-readable medium that stores a set of instructions for wireless communication by a UE. The set of instructions, when executed by one or more processors of the UE, may cause the UE to receive, from a network node and via a primary cell, first configuration information associated with a secondary cell indicating a first carrier frequency associated with the secondary cell, the first carrier frequency being associated with a first coverage area of the secondary cell. The set of instructions, when executed by one or more processors of the UE, may cause the UE to communicate, via the secondary cell, a first one or more signals using the first carrier frequency. The set of instructions, when executed by one or more processors of the UE, may cause the UE to receive, from the network node and via the primary cell, second configuration information associated with the secondary cell indicating a second carrier frequency associated with the secondary cell based at least in part on a location of the UE changing from the first coverage area to a second coverage area of the secondary cell. The set of instructions, when executed by one or more processors of the UE, may cause the UE to communicate, via the secondary cell, a second one or more signals using the second carrier frequency.

Some aspects described herein relate to a non-transitory computer-readable medium that stores a set of instructions for wireless communication by a repeater. The set of instructions, when executed by one or more processors of the repeater, may cause the repeater to receive, from a network node and via a primary cell, configuration information for a secondary cell, the configuration information indicating a first carrier frequency and a second carrier frequency to be used for the secondary cell, the first carrier frequency and the second carrier frequency being included in a frequency band. The set of instructions, when executed by one or more processors of the repeater, may cause the repeater to receive, via the first carrier frequency, a first one or more signals associated with the secondary cell. The set of instructions, when executed by one or more processors of the repeater, may cause the repeater to transmit, via the second carrier frequency, a second one or more signals, the second one or more signals being associated with an analog repeating operation of the first one or more signals.

Some aspects described herein relate to a non-transitory computer-readable medium that stores a set of instructions for wireless communication by a network node. The set of instructions, when executed by one or more processors of the network node, may cause the network node to transmit first configuration information, for a repeater, associated with a secondary cell, the first configuration information indicating a first carrier frequency and a second carrier frequency to be used for the secondary cell, the first configuration information indicating that the repeater is to use the first carrier frequency for receiving operations and the second carrier frequency for transmitting operations, and the first carrier frequency and the second carrier frequency being included in a frequency band. The set of instructions, when executed by one or more processors of the network node, may cause the network node to transmit second configuration information, for a UE, associated with the secondary cell, the second configuration information indicating a first operating frequency, from the first carrier frequency or the second carrier frequency, for the secondary cell.

Some aspects described herein relate to an apparatus for wireless communication. The apparatus may include means for receiving, from a network node and via a primary cell, first configuration information associated with a secondary cell indicating a first carrier frequency associated with the secondary cell, the first carrier frequency being associated with a first coverage area of the secondary cell. The apparatus may include means for communicating, via the secondary cell, a first one or more signals using the first carrier frequency. The apparatus may include means for receiving, from the network node and via the primary cell, second configuration information associated with the secondary cell indicating a second carrier frequency associated with the secondary cell based at least in part on a location of the apparatus changing from the first coverage area to a second coverage area of the secondary cell. The apparatus may include means for communicating, via the secondary cell, a second one or more signals using the second carrier frequency.

Some aspects described herein relate to an apparatus for wireless communication. The apparatus may include means for receiving, from a network node and via a primary cell, configuration information for a secondary cell, the configuration information indicating a first carrier frequency and a second carrier frequency to be used for the secondary cell, the first carrier frequency and the second carrier frequency being included in a frequency band. The apparatus may include means for receiving, via the first carrier frequency, a first one or more signals associated with the secondary cell. The apparatus may include means for transmitting, via the second carrier frequency, a second one or more signals, the second one or more signals being associated with an analog repeating operation of the first one or more signals.

Some aspects described herein relate to an apparatus for wireless communication. The apparatus may include means for transmitting first configuration information, for a repeater, associated with a secondary cell, the first configuration information indicating a first carrier frequency and a second carrier frequency to be used for the secondary cell, the first configuration information indicating that the repeater is to use the first carrier frequency for receiving operations and the second carrier frequency for transmitting operations, and the first carrier frequency and the second carrier frequency being included in a frequency band. The apparatus may include means for transmitting second configuration information, for a UE, associated with the secondary cell, the second configuration information indicating a first operating frequency, from the first carrier frequency or the second carrier frequency, for the secondary cell.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

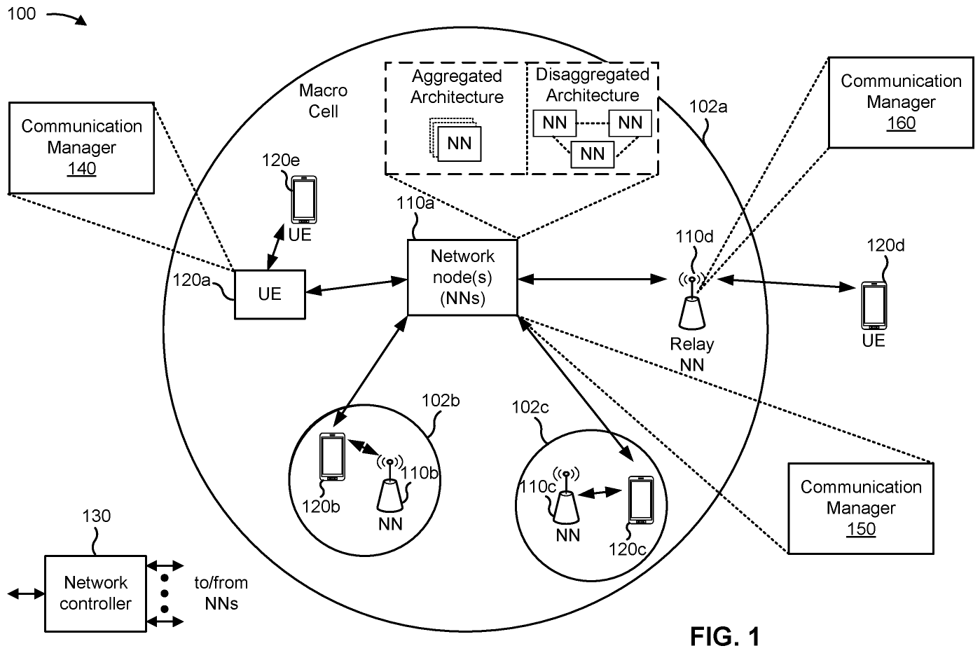

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a given geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like. In some examples, the network node 110d may be a repeater. A repeater may be a device that receives a signal, amplifies the signal (e.g., performs power amplification), and transmits the signal. A relay may perform additional processing of the signal (e.g., as compared to a repeater), such as digital processing, decoding, demodulation, modulation, and/or encoding, among other examples. For example, the network node 110d may be an analog repeater (e.g., that does not perform processing of signals in the digital domain).

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a given RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band. In some examples, the higher frequency bands may include a sub-terahertz (sub-THz) frequency band. The sub-THz frequency band may include frequencies included in the FR4a, FR4-1, FR4, FR5, or higher frequencies. For example, the sub-THz frequency band may include frequencies greater than 100 GHz. In some cases, the sub-THz frequency band may include frequencies in the range of 90 GHz-300 GHz.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a network node and via a primary cell, first configuration information associated with a secondary cell indicating a first carrier frequency associated with the secondary cell, the first carrier frequency being associated with a first coverage area of the secondary cell; communicate, via the secondary cell, a first one or more signals using the first carrier frequency; receive, from the network node and via the primary cell, second configuration information associated with the secondary cell indicating a second carrier frequency associated with the secondary cell based at least in part on a location of the UE changing from the first coverage area to a second coverage area of the secondary cell; and communicate, via the secondary cell, a second one or more signals using the second carrier frequency. Additionally, or alternatively, the communication manager 140 may perform one or more other operations described herein.

In some aspects, the network node 110 may include a communication manager 150. As described in more detail elsewhere herein, the communication manager 150 may transmit first configuration information, for a repeater, associated with a secondary cell, the first configuration information indicating a first carrier frequency and a second carrier frequency to be used for the secondary cell, the first configuration information indicating that the repeater is to use the first carrier frequency for receiving operations and the second carrier frequency for transmitting operations, and the first carrier frequency and the second carrier frequency being included in a frequency band; and transmit second configuration information, for a UE, associated with the secondary cell, the second configuration information indicating a first operating frequency, from the first carrier frequency or the second carrier frequency, for the secondary cell. Additionally, or alternatively, the communication manager 150 may perform one or more other operations described herein.

In some aspects, a repeater (e.g., the network node 110d, a UE, or another wireless communication device) may include a communication manager 160. As described in more detail elsewhere herein, the communication manager 160 may receive, from a network node and via a primary cell, configuration information for a secondary cell, the configuration information indicating a first carrier frequency and a second carrier frequency to be used for the secondary cell, the first carrier frequency and the second carrier frequency being included in a frequency band; receive, via the first carrier frequency, a first one or more signals associated with the secondary cell; and transmit, via the second carrier frequency, a second one or more signals, the second one or more signals being associated with an analog repeating operation of the first one or more signals. Additionally, or alternatively, the communication manager 160 may perform one or more other operations described herein.

As indicated above, FIG. 1 is provided as an example. Other examples may differ from what is described with regard to FIG. 1.

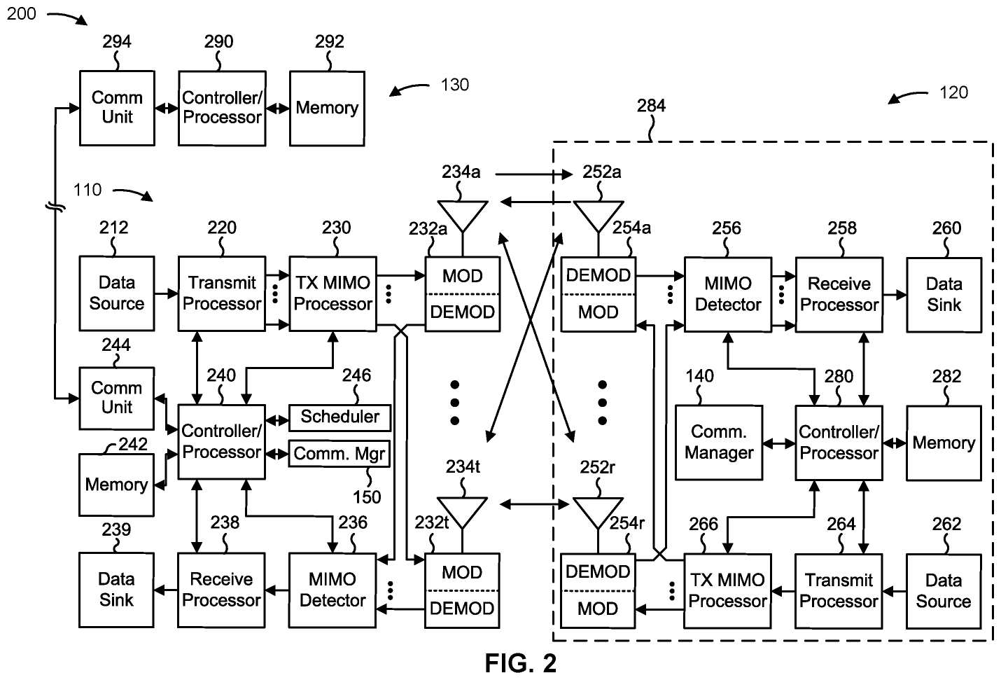

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

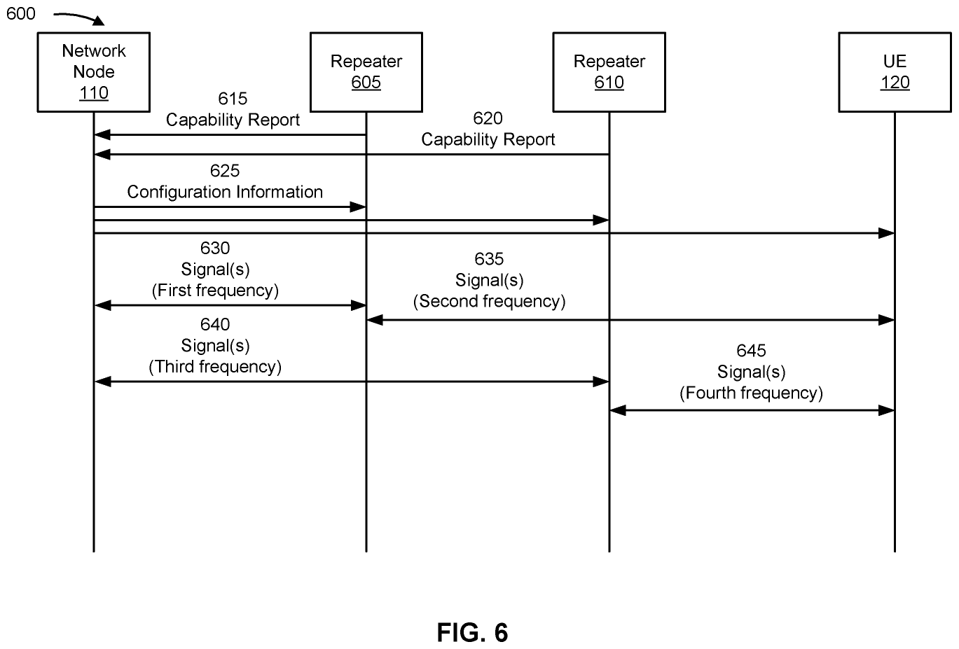

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-13).

The controller/processor 240 of the network node 110, the controller/processor 280 of the UE 120, and/or any other component(s) of FIG. 2 may perform one or more techniques associated with different carrier frequencies for secondary cell (SCell) coverage, as described in more detail elsewhere herein. In some aspects, the repeater described herein is the network node 110, is included in the network node 110, or includes one or more components of the network node 110 shown in FIG. 2. Additionally, or alternatively, the repeater described herein may be the UE 120, may be included in the UE 120, or may include one or more components of the UE 120 shown in FIG. 2

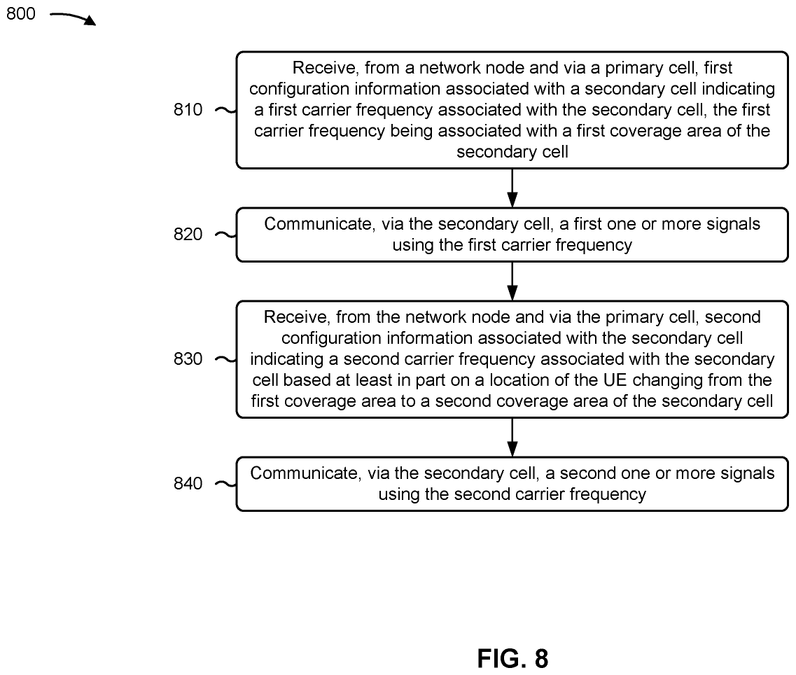

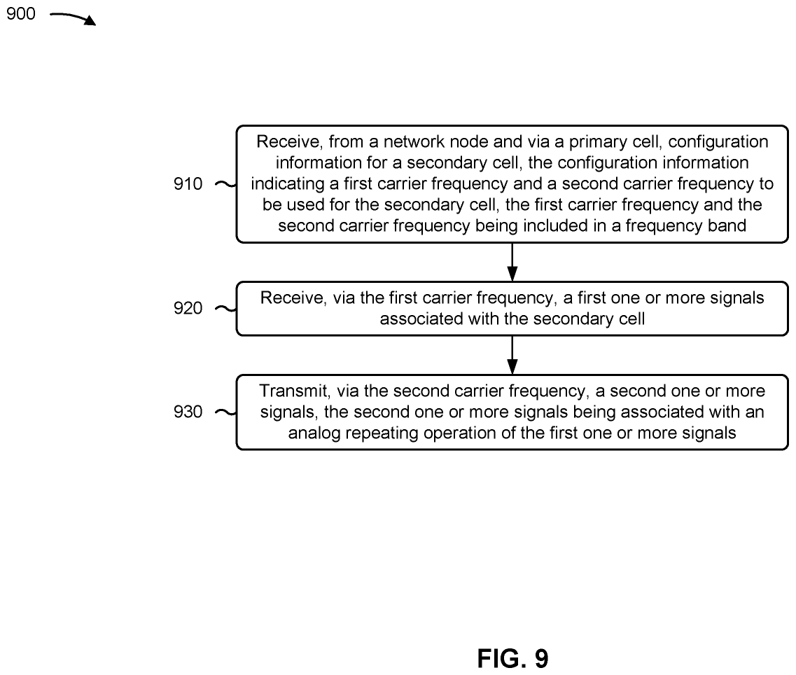

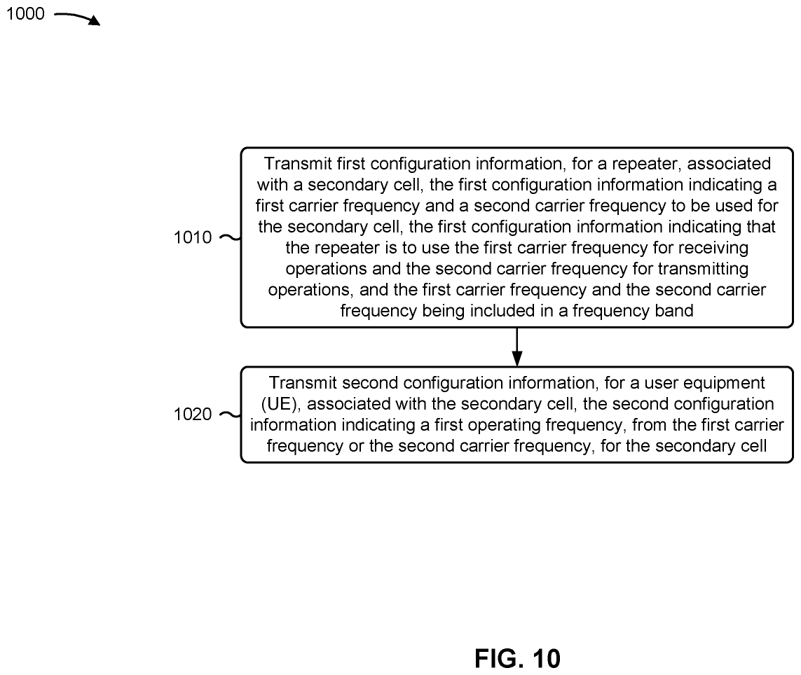

For example, the controller/processor 240 of the network node 110, the controller/processor 280 of the UE 120, and/or any other component(s) of FIG. 2 may perform or direct operations of, for example, process 800 of FIG. 8, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE 120 includes means for receiving, from a network node and via a primary cell, first configuration information associated with a secondary cell indicating a first carrier frequency associated with the secondary cell, the first carrier frequency being associated with a first coverage area of the secondary cell; means for communicating, via the secondary cell, a first one or more signals using the first carrier frequency; means for receiving, from the network node and via the primary cell, second configuration information associated with the secondary cell indicating a second carrier frequency associated with the secondary cell based at least in part on a location of the UE changing from the first coverage area to a second coverage area of the secondary cell; and/or means for communicating, via the secondary cell, a second one or more signals using the second carrier frequency. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the repeater includes means for receiving, from a network node and via a primary cell, configuration information for a secondary cell, the configuration information indicating a first carrier frequency and a second carrier frequency to be used for the secondary cell, the first carrier frequency and the second carrier frequency being included in a frequency band; means for receiving, via the first carrier frequency, a first one or more signals associated with the secondary cell; and/or means for transmitting, via the second carrier frequency, a second one or more signals, the second one or more signals being associated with an analog repeating operation of the first one or more signals. In some aspects, the means for the repeater to perform operations described herein may include, for example, one or more of communication manager 160, transmit processor 220, TX MIMO processor 230, modem 232, antenna 234, MIMO detector 236, receive processor 238, controller/processor 240, memory 242, or scheduler 246. In some aspects, the means for the repeater to perform operations described herein may include, for example, one or more of communication manager 160, antenna 252, modem 254, MIMO detector 256, receive processor 258, transmit processor 264, TX MIMO processor 266, controller/processor 280, or memory 282.

In some aspects, the network node 110 includes means for transmitting first configuration information, for a repeater, associated with a secondary cell, the first configuration information indicating a first carrier frequency and a second carrier frequency to be used for the secondary cell, the first configuration information indicating that the repeater is to use the first carrier frequency for receiving operations and the second carrier frequency for transmitting operations, and the first carrier frequency and the second carrier frequency being included in a frequency band; and/or means for transmitting second configuration information, for a UE, associated with the secondary cell, the second configuration information indicating a first operating frequency, from the first carrier frequency or the second carrier frequency, for the secondary cell. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

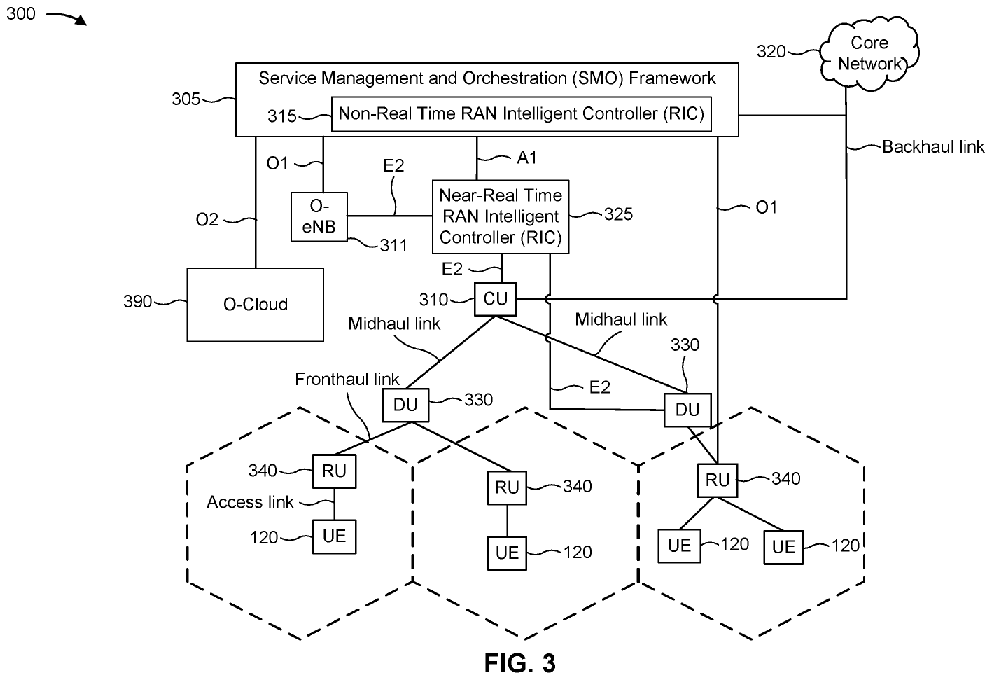

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

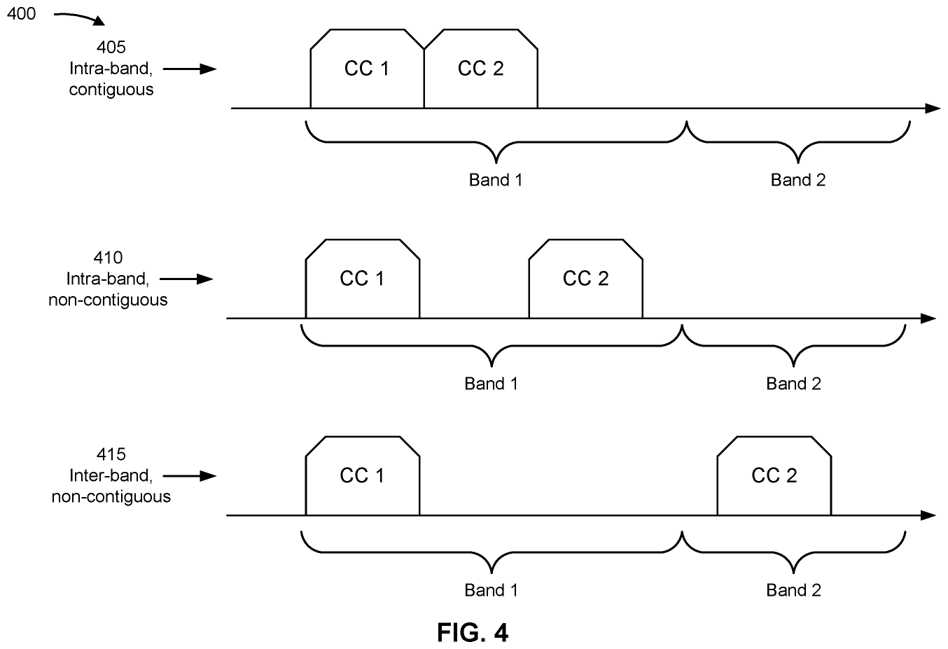

FIG. 4 is a diagram illustrating examples 400 of carrier aggregation, in accordance with the present disclosure.

Carrier aggregation is a technology that enables two or more component carriers (CCs, sometimes referred to as carriers) to be combined (e.g., into a single channel) for a single UE 120 to enhance data capacity. As shown, carriers can be combined in the same or different frequency bands. Additionally, or alternatively, contiguous or non-contiguous carriers can be combined. A network node 110 may configure carrier aggregation for a UE 120, such as in an RRC message, downlink control information (DCI), and/or another signaling message.

As shown by reference number 405, in some aspects, carrier aggregation may be configured in an intra-band contiguous mode where the aggregated carriers are contiguous to one another and are in the same band. As shown by reference number 410, in some aspects, carrier aggregation may be configured in an intra-band non-contiguous mode where the aggregated carriers are non-contiguous to one another and are in the same band. As shown by reference number 415, in some aspects, carrier aggregation may be configured in an inter-band non-contiguous mode where the aggregated carriers are non-contiguous to one another and are in different bands.

In carrier aggregation, a UE 120 may be configured with a primary carrier or primary cell (PCell) and one or more secondary carriers or secondary cells (SCells). In some aspects, the primary carrier may carry control information (e.g., downlink control information and/or scheduling information) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling.

In some examples, for inter-band carrier aggregation, a PCell may be associated with a first frequency band, and an SCell may be associated with a second frequency band, where the first frequency band is associated with a lower frequency than the second frequency band. For example, the PCell may be associated with an FR1 band, an FR2 band, or an FR4 band, among other examples, and the SCell may be associated with a sub-THz band. In some examples, due to a reduced coverage area of the secondary cell (e.g., caused by using the higher frequency band), the UE may rely on a connection with the primary cell to obtain information associated with the secondary cell. For example, an SCell deployment may rely on PCell connectivity to support a power efficient sub-THz deployment with a burst activity pattern on the secondary cell. In some examples, the SCell (e.g., the sub-THz cell) may be collocated with the PCell (e.g., the PCell and the SCell may be associated with the same network node or network nodes that are collocated). In other examples, the SCell may not be collocated with the PCell.

As indicated above, FIG. 4 is provided as an example. Other examples may differ from what is described with regard to FIG. 4.

In some network deployments, cells may be deployed that operate using high frequency bands, such as the EHF band, FR3, FR4, FR5, a sub-THz band (e.g., which may include frequencies that are multiple hundreds of GHz, such as 100 GHz-300 GHz), and/or other high frequency bands. The cells operating using high frequency bands may be referred to herein as “high-band cells.” The high-band cells may provide increased data capacity and/or increased throughput for UEs (e.g., because of an increased bandwidth associated with the high frequency bands). For example, a UE 120 and a network node 110 associated with a high-band cell may communicate using a larger bandwidth size, such as a 7.5 GHz bandwidth, among other examples. Communicating using the larger bandwidth size may result in an increased throughput for communications between the UE 120 and the network node 110.

RF constraints and propagation properties that are associated with the high frequency bands may introduce new design challenges for wireless networks. For example, the high frequency bands may be associated with a high path loss. Therefore, to compensate for the high path loss, the network node 110 and the UE 120 may communicate using narrow beams (for example, beams with a narrow beam width or signals with energy concentrated over a narrow directional range). In such examples, spatial division multiplexing (SDM) may be used (for example, where different, spatially separable antenna beams are formed for different UEs). However, the narrow beams may be susceptible to beam blockage, interference, or other intervening factors that degrade performance of signals communicated via the narrow beams. Therefore, high-band cells may be associated with a smaller coverage area (e.g., a geographic area associated with a cell) as compared to cells using a lower operating frequency (e.g., which may be referred to herein as “low-band cells”). Because of the smaller coverage area of high-band cells, in some network deployments, high-band cells may be more densely distributed in the wireless network as compared to low-band cells. For example, multiple high-band network nodes (e.g., multiple RUs) may be deployed within a coverage area of a single low-band network node (e.g., within a coverage area of a low-band cell).

Additionally, high frequency (e.g., sub-THz) operations may be associated with a decreased efficiency of a power amplifier of the UE or network node. For example, a power amplifier power may decrease as a function of frequency and as a function of bandwidth. Therefore, high frequency (e.g., sub-THz) operations may be associated lower power amplifier power and lower power amplifier efficiency. This may result in a reduced effective isotropic radiated power (EIRP) that a device is capable of producing, resulting in the reduced coverage for high-band cells. As another example, high frequency (e.g., sub-THz) operations may be associated with increased power consumption. For example, high frequency (e.g., sub-THz) operations may be associated with a larger bandwidth (e.g., due to a larger subcarrier spacing) and high data rates. The larger bandwidth, coupled with less power efficient RF processing, increased sampling rates (e.g., for an analog-to-digital converter or a digital-to-analog converter), increased digital processing rates, increased bit rates, and/or increased storage or memory requirements, among other examples, may increase power consumption of wireless communication devices using the high frequency bands, such as the sub-THz band.

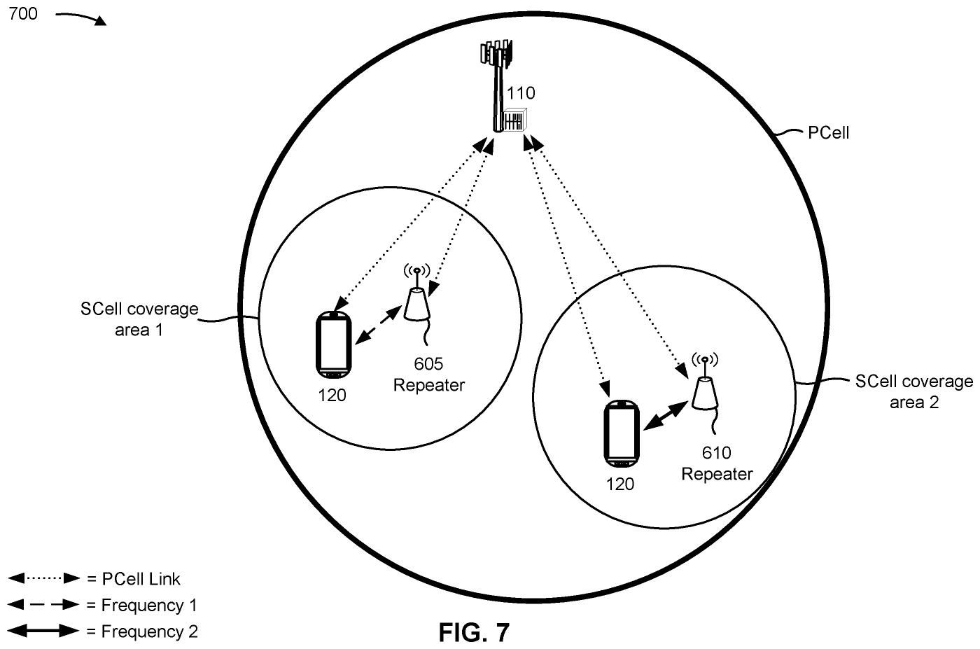

The poor coverage, increased power consumption, and narrow beams associated with high-band cells (e.g., sub-THz cells or other high-band cells) may introduce challenges for beam management. For example, as operational frequencies increase from mmW frequency ranges to sub-THz frequency ranges, beam widths may decrease (e.g., linearly) while a quantity of beams may increase (e.g., quadratically). In other words, to support high frequency band operations, such as sub-THz operations, a quantity of antenna elements in an antenna panel may be increased (e.g., to support forming an increased quantity of beams and/or narrower beams). For example, when increasing from an operating frequency of 28 GHz to 140 GHz, a ⅕ beam width reduction may result in 25 times (e.g., x25) more beams for the same array area (e.g., for the same antenna panel). With such a large quantity of beams available, a signaling overhead associated with beam management procedures may be increased (e.g., due to a UE and/or a network node having to scan or sweep over a large quantity of narrow beams, in a similar manner as described above in connection with FIG. 7). Additionally, the increased quantity of beams may introduce latency associated with performing beam management procedures via the increased quantity of beams. Further, because the high frequency operations may be associated with an increased power consumption, performing beam management over the increased quantity of beams may consume significant power resources of wireless communication devices.

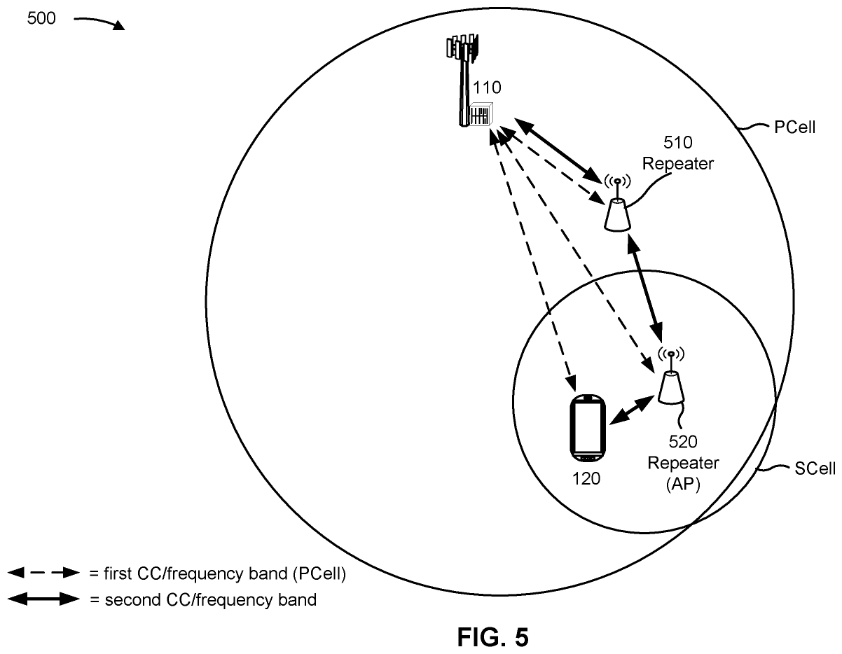

FIG. 5 is a diagram illustrating example 500 of a network deployment, in accordance with the present disclosure. In some examples, the network deployment depicted in FIG. 5 may support sub-THz communications. For example, the network deployment may utilize APs (also referred to herein as repeaters) in areas with high data volume demand potential. In some examples, the APs may provide a high capacity channel for sub-THz eligible (e.g., supporting sub-THz communication and satisfying a list of preconditions) UEs registered and continuously connected to a lower frequency band primary cell or “master” cell (e.g., FR1/FR2 based cell such as a PCell an SCell on a lower frequency band compared to sub-THz band). The APs may provide a local spot-based coverage with increased capacity under a wider PCell (e.g., FR1 based PCell) or a lower frequency band SCell (e.g., FR2 based SCell) coverage range.

The sub-THz communication may be a supplementary high capacity channel that may be deployed as a secondary cell with burst activity pattern for sparse usage in time for sub-THz eligible UEs. The sub-THz eligible UE may be continuously connected to the PCell via the lower frequency band (e.g., FR1/FR2/FR4) as one of the prerequisites for a more power efficient spot based sub-THz deployment that may rely on inter-band carrier aggregation. As used herein, “primary cell,” “PCell,” or “master cell” may be used interchangeably and may refer to a lower frequency band cell where initial connection between the sub-THz eligible UE and network node is established and continuously maintained, while this continuous connection is used as a reference for coarse synchronization and beam management procedures for a higher frequency band based SCell (e.g., a sub-THz based SCell) and is also used for all the registration and any control plane signaling for the sub-THz based SCell.

As used herein, “secondary cell” or “SCell” may refer to a non-primary cell. In some examples, a UE may receive control information over a PCell and an SCell may be used for data signaling (e.g., to increase throughput of the UE). Correspondingly, a sub-THz based SCell may support a scope of functionality and may rely on PCell connectivity in many aspects (e.g., sub-THz related control signaling, coarse synchronization and coarse beam management supporting a dynamic low latency and low power and low complexity activation/deactivation procedures). A sub-THz based SCell may enable a spot-based coverage under a lower band PCell coverage range and may be used for a significant volume data offloading using a relatively short data offloading sessions for sub-THz eligible UEs (with preconditions).

As shown in FIG. 5, the network deployment may include a network node 110 that supports a PCell. The network deployment may include a repeater 510. The repeater 510 may be referred to as a rendezvous point (RP). An SCell may be supported by a repeater 520. The repeater 520 may be referred to as an AP. For example, the repeater 520 may enable the UE 120 to communicate via a sub-THz frequency band, as described in more detail herein.

As shown in FIG. 5, inter-band carrier aggregation may be used where a sub-THz frequency band is used on the SCell providing a spot based sub-THz coverage under a wider PCell coverage range and the PCell may use a lower frequency band (e.g., FR1/FR2/FR4). The sub-THz SCell may support a scope of functionality and may rely on PCell/lower frequency band cell for wireless communication functionality. For example, the SCell may not support any “always on” signals or resources reservation (e.g., signal that are always present on the sub-THz SCell such as synchronization signal blocks (SSBs), random access channel (RACH) occasion signaling, periodic reference signals, and/or control signaling).

In some examples, the SCell may be activated dynamically on demand (e.g., for sporadic and short time sessions, that may have a burst activity pattern). Coarse synchronization and beam management for SCell/sub-THz may be determined based on the PCell. There may be a complementary synchronization and beam refinement procedures carried out at each activation of the SCell, and the SCell synchronization and beam management (BM) may be at least partially based on the PCell. As shown in FIG. 5, there may be single or multi-hop repeating (e.g., enabled by the repeater 510 and the repeater 520 to the UE 120) between sub-THz UE and sub-THz network node (e.g., the network node 110) transceiver to bridge over a limited sub-THz range. In some examples, the multi-hop repeating may be associated with difference frequency bands on different hops (e.g., a first hop may use a first frequency band, a second hop may use a second frequency band, and a third hop may use a third frequency band (or the first frequency band)).

The repeaters (such as the repeater 510 and the repeater 520) may be efficient smart repeaters with out-of-band (OOB) control based on PCell connectivity of all the sub-THz link components (e.g., UEs, APs or intermediate repeaters in case of multi hop sub-THz links). The repeaters may include different functional components such as (1) a reduced capability (RedCap) UE (RC UE) for PCell connectivity (e.g., to deliver OOB control/reports/feedbacks), (2) an analog amplify and forward (AF) functionality for sub-THz data forwarding, and/or (3) dedicated component for sub-THz local complementary synchronization and beam management sessions using a dedicated synchronization and beam management reference signal (or modified waveform localized in time SSB mini-bursts) transmit (Tx) and/or receive (Rx) capability over the sub-THz on SCell, among other examples. Multi hop sub-THz links may be established and/or activated and synchronized using progressive synchronization across hops with hop specific synchronization and beam management sessions with customized synchronization and beam management reference signal mini-burst scheduling (by a network node over the PCell) for transmission and reception from a first sub-THz hop edge (Tx side) to a corresponding second sub-THz hop edge (Rx side to sync on the Tx side).

In some examples, sub-THz communication may be supported in a non-standalone fashion as an SCell (or secondary component carrier) while the corresponding PCell (or primary component carrier) may be on a lower frequency range (e.g., FR1/FR2/FR4) and may serve as master cell connectivity to support the sub-THz communication (which may be with a burst activity pattern).

As used herein, the term “repeater” may refer to a network controlled repeater (e.g., which may be an AP for direct connection with UEs, an RP for intermediate or direct link with network node, such as network node, or a mixed type that combines functionality of AP and RP) that may receive a transmission, and perform network controlled amplify and forward to transmit the transmission to a UE, a network node, or another repeater. As used herein, the term “sub-THz repeater” may refer to a repeater for amplifying and forwarding sub-THz communications (e.g., control information for a sub-THz repeater may be on a different frequency band). In some examples, the repeater may be an analog repeater (e.g., a repeater that does not perform digital processing of signals). In some examples, a repeater may be a UE, a network node, and/or an RU, among other examples.

For sub-THz communications, in order to achieve a denser sub-THz coverage, a denser geographical distribution of sub-THz transceivers may be used. If each sub-THz coverage spot is associated with a sub-THz network node or cell (with a direct links to sub-THz eligible UEs), full digital demodulation and decoding procedures of sub-THz signals may be done locally for each spot before backhauling the integrated and remodulated data to a PCell network node. Given a high quantity of sub-THz transceivers that may be used to cover PCell coverage range, the power consumption may be large. Aspects provided herein provide mechanisms for enabling multi-hop (e.g., enabled by multiple repeaters) sub-THz deployment to increase the supported spot-based sub-THz coverage range/coverage density with a small power consumption or energy investment to allow a more power efficient sub-THz deployment. In order to improve network energy efficiency characteristics for sub-THz deployment, aspects provided herein may enable an extended range multi-hop sub-THz links based on repeaters with analog sub-THz signal processing (AP/RP) (e.g., amplify and forward analog processing) allowing a non-direct UE to sub-THz network node connection to be employed instead of a more power-hungry approach based on multiple sub-THz small cells. For example, a repeater (e.g., an analog repeater) may operate using analog processing and relay signals in the analog domain (e.g., the repeater may not perform operations in the digital domain, thereby conserving processing resources and power resources).

However, a repeater that uses analog sub-THz signal processing (e.g., a repeater that does not perform one or more digital processing operations, such as analog to digital conversion or digital to analog conversion) may experience noise or interference caused by Tx-to-Rx leakage. For example, Tx-to-Rx leakage may refer to Rx components (e.g., an Rx antenna element) of a repeater receiving a signal that is transmitted via a Tx component (e.g., a Tx antenna element) of the repeater (e.g., the same repeater). For example, because Rx elements and Tx elements of the repeater may use the same, or similar, operating frequency or carrier frequency, the repeater may experience degraded performance caused by Tx-to-Rx leakage. To mitigate negative effects caused by the Tx-to-Rx leakage, a maximum transmit power of the repeater may be limited. As a result, a range of a link between two repeaters (e.g., the repeater 510 and the repeater 520) and/or a range of a coverage area of the SCell may be reduced. This may reduce a range or coverage area for sub-THz communications using the network deployment depicted in FIG. 5.

Some techniques and apparatuses described herein enable different carrier frequencies for SCell coverage. In some aspects, different coverage areas of an SCell may be configured with different carrier frequencies (e.g., different sub-THz frequencies). For example, an SCell may include multiple coverage areas (e.g., where a coverage area is served by a repeater). Different carrier frequencies may be used for the SCell coverage areas within the same SCell.

For example, a UE may receive, from a network node and via a PCell, first configuration information associated with an SCell indicating a first carrier frequency associated with the secondary cell, the first carrier frequency being associated with a first coverage area of the secondary cell. The UE may communicate, via the SCell, a first one or more signals using the first carrier frequency. The UE may receive, from the network node and via the PCell, second configuration information associated with the secondary cell indicating a second carrier frequency associated with the secondary cell based at least in part on a location of the UE changing from the first coverage area to a second coverage area of the secondary cell. The UE may communicate, via the SCell, a second one or more signals using the second carrier frequency. In other words, as the UE moves between coverages areas of the SCell, the UE may use different carrier frequencies (e.g., different carrier frequencies within a sub-THz frequency band).

In some aspects, each coverage area may be associated with a repeater (e.g., an analog repeater). For example, a repeater may receive, from a network node and via the PCell, configuration information for a secondary cell, the configuration information indicating a first carrier frequency and a second carrier frequency to be used for the secondary cell, the first carrier frequency and the second carrier frequency being included in the same frequency band (e.g., a sub-THz frequency band). The repeater may receive, via the first carrier frequency, a first one or more signals associated with the secondary cell. The repeater may transmit, via the second carrier frequency, a second one or more signals, the second one or more signals being associated with an analog repeating operation of the first one or more signals. For example, the repeater may use different carrier frequencies for Tx operations and Rx operations associated with serving a coverage area of an SCell.

As a result, the repeater may mitigate noise or interference caused by Tx-to-Rx leakage. For example, different carrier frequencies may be used on different sides of an analog repeater (Tx and Rx) to increase Tx to Rx isolation based on frequency domain separation. Frequency domain-based separation of Tx and Rx signals on the repeater side allows to avoid nonstable and/or resonating power loops. Using analog repeaters may improve a power efficiency of the repeaters (e.g., as compared to repeaters that perform digital processing). Additionally, by enabling a repeater to use different frequencies and/or different frequency bands for a repeating operation, a transmit power (e.g., an allowed transmit power) of the repeater may be increased. For example, the repeater may use a larger amplification factor for analog repeating operations associated with the network deployment, such as the network deployment depicted in FIG. 5. This may improve a range and/or coverage area of the repeater. By increasing the range and/or coverage area of the repeater, a range and/or coverage area of a sub-THz network deployment (such as the network deployment depicted in FIG. 5) may be increased. Further, increasing the amplification factor used by the repeater may increase a throughput of the multi-hop link. By increasing Tx to Rx isolation at repeaters (e.g., by enabling the repeaters to use different carrier frequencies), an error vector magnitude (EVM) of different hops of a multi-hop link may be improved (e.g., because the EVM may not be limited by in-channel Tx to Rx leaking of the repeaters).

Additionally, a multi-hop link configuration and activation procedure may be simplified because different hops of the multi-hop link that use different carrier frequencies and/or sub-bands may be addressed as the same SCell. For example, the network (e.g., a network node) may be enabled to configure the different coverage areas to use different carrier frequencies under the same SCell configuration, thereby simplifying the configuration and/or activation of the coverage areas (e.g., as compared to configuring different SCell configurations for each different carrier frequency). Further, the network node may be enabled to co-schedule different UEs (e.g., accessing an SCell using different repeaters and/or coverage areas) that share one or more common hops of a multi-hop link (e.g., to the network node).

As indicated above, FIG. 5 is provided as an example. Other examples may differ from what is described with regard to FIG. 5.

FIG. 6 is a diagram of an example 600 associated with different carrier frequencies for SCell coverage, in accordance with the present disclosure. As shown in FIG. 6, a network node 110 (e.g., a base station, a CU, a DU, and/or an RU) may communicate with a UE 120 via one or more repeaters, such as a repeater 605 and/or a repeater 610. In some aspects, the network node 110, the repeater 605, the repeater 610, and the UE 120 may be part of a wireless network (e.g., the wireless network 100). The UE 120 and the network node 110 may have established a wireless connection prior to operations shown in FIG. 6.

In some aspects, the network node 110, the repeater 605, the repeater 610, and the UE 120 may be part of a wireless network that uses one or more sub-THz frequency bands for communication. The network node 110, the repeater 605, the repeater 610, and the UE 120 may be part of a network deployment similar to the network deployment depicted in FIG. 5. For example, the network node 110 may be associated with a PCell. The repeater 605 and the repeater 610 may be associated with an SCell (e.g., a sub-THz SCell). The repeater 610 may be an AP and the repeater 605 may be an RP. Alternatively, both the repeater 605 and the repeater 610 may be RPs. In some aspects, the repeater 605 and the repeater 610 may communicate via a line-of-sight (LOS) link or a near LOS link. In some aspects, the repeater 605 may be associated with (e.g., may serve) a first coverage area of the SCell and the repeater 610 may be associated with (e.g., may server) a second coverage area of the SCell. For example, the repeater 605 and the repeater 610 may be associated with spot-based coverage for the SCell.

The repeater 605 and/or the repeater 610 may be analog repeaters. For example, the repeater 605 and/or the repeater 610 may be any wireless communication device capable of receiving a transmission, performing network controlled amplify and forward to transmit (e.g., to repeat) the transmission to a UE, a network node, and/or another repeater, among other examples. The repeater 605 and/or the repeater 610 may not perform digital processing of signals that are repeated (e.g., amplified and forwarded) by the repeater 605 and/or the repeater 610. For example, the repeater 605 and/or the repeater 610 may be similar to the repeaters described in connection with FIG. 5.

In some aspects, actions described herein as being performed by a network node 110 may be performed by multiple different network nodes. For example, configuration actions may be performed by a first network node (for example, a CU or a DU), and radio communication actions may be performed by a second network node (for example, a DU or an RU). As used herein, the network node 110 “transmitting” a communication to the UE 120 and/or a repeater may refer to a direct transmission (for example, from the network node 110 to the UE 120 or repeater) or an indirect transmission via one or more other network nodes or devices. For example, if the network node 110 is a DU, an indirect transmission to the UE 120 or repeater may include the DU transmitting a communication to an RU and the RU transmitting the communication to the UE 120 or the repeater. Similarly, the UE 120 or a repeater “transmitting” a communication to the network node 110 may refer to a direct transmission (for example, from the repeater or the UE 120 to the network node 110) or an indirect transmission via one or more other network nodes or devices. For example, if the network node 110 is a DU, an indirect transmission to the network node 110 may include the repeater or the UE 120 transmitting a communication to an RU and the RU transmitting the communication to the DU.

As shown by reference number 615, the repeater 605 may transmit, and the network node 110 may receive, a capability report. The repeater 605 may transmit the capability report via the PCell. For example, the repeater 605 may transmit, and the network node 110 may receive, a capability communication (e.g., the capability report) indicating that the repeater 605 supports using different carrier frequencies for an SCell. For example, the repeater 605 may support a frequency conversion functionality for an analog amplify and forward component of the repeater 605. For example, the repeater may include a frequency conversion component to enable the repeater 605 to convert a frequency of signals (e.g., from a first carrier frequency to a second carrier frequency) as part of an analog amplify and forward repeating operation. The repeater 605 may report a capability to support two different carrier frequencies for Tx and Rx operations.

In some aspects, the capability communication (e.g., the capability report) may indicate a range of frequencies supported for using different carrier frequencies for the SCell. For example, the repeater 605 may indicate a supported and/or tunable range of frequencies (e.g., sub-THz frequencies) supported by the repeater 605. Additionally, or alternatively, the capability communication (e.g., the capability report) may indicate a supported transmit power amplification associated with using different carrier frequencies for the SCell during the analog repeating operation. For example, the repeater 605 may indicate a supported amplification gain and/or a supported Tx power for a single frequency mode and/or for a two frequency mode. The single frequency mode may be associated with the repeater 605 using a single carrier frequency for Tx and Rx operations. The two frequency mode may be associated with the repeater 605 using different carrier frequencies for Tx and Rx operations. In some aspects, the supported amplification gain and/or the supported Tx power may be a maximum supported amplification gain and/or a maximum supported Tx power.

As shown by reference number 620, the repeater 610 may transmit, and the network node 110 may receive, a capability report. The repeater 610 may transmit the capability report via the PCell. For example, the repeater 610 may transmit, and the network node 110 may receive, a capability communication (e.g., the capability report) indicating that the repeater 610 supports using different carrier frequencies for the SCell. For example, the repeater 610 may transmit the capability communication in a similar manner as described in connection with the repeater 605 (e.g., and reference number 615).

As shown by reference number 625, the network node 110 may transmit, and the repeater 605, the repeater 610, and/or the UE 120 may receive, configuration information. In some aspects, the repeater 605, the repeater 610, and/or the UE 120 may receive the configuration information via one or more of system information signaling, RRC signaling, one or more MAC control elements (MAC-CEs), and/or DCI, among other examples. In some aspects, the configuration information may include an indication of one or more configuration parameters for selection, and/or explicit configuration information, among other examples. In some aspects, the network node 110 may determine the configuration information. In some aspects, another device (e.g., another network node, a CU, or a core network device) may determine the configuration and may transmit the configuration information to the network node 110. The network node 110 and/or the other device may determine the configuration based at least in part on the capability report(s) received by the network node 110 (e.g., from the repeater 605 and/or from the repeater 610). For example, the configuration information may indicate that the repeater 605 and/or the repeater 610 are to use different frequencies for transmitting and receiving operations based at least in part on the capability report(s) indicating that the repeater 605 and/or the repeater 610 support such operations.

In some aspects, the configuration information may indicate that the repeater 605 and/or the repeater 610 are to use different frequencies for transmitting and receiving operations. For example, the configuration information may indicate that the repeater 605 is to use a first carrier frequency (e.g., a sub-THz frequency) for communications with the network node 110 and a second carrier frequency (e.g., a different sub-THz frequency) for communications with a next hop in the multi-hop link (e.g., with the repeater 610 and/or the with the UE 120). Similarly, the configuration information may indicate that the repeater 610 is to use a first carrier frequency (e.g., a sub-THz frequency) for communications with the UE 120 and a second carrier frequency (e.g., a different sub-THz frequency) for communications with a next hop in the multi-hop link (e.g., with the repeater 605 or with the network node 110). In other words, each repeater may be configured with multiple (e.g., two or more) frequencies for an SCell. The repeaters (e.g., the repeater 605 and/or the repeater 610) may use different carrier frequencies for transmitting and receiving operations for serving the SCell.

For example, the configuration information may include an SCell configuration. In some aspects, the configuration information may include a carrier aggregation configuration that includes an SCell configuration. For example, the configuration information may include a cell group configuration (e.g., a CellGroupConfig). In some aspects, the configuration information may include a component carrier configuration. For example, a component carrier (e.g., associated with the SCell) may be configured for the repeater 605 and/or the repeater 610 with multiple (e.g., different) carrier frequencies. The repeater 605 and/or the repeater 610 may receive the configuration information via an OOB control link with the network node 110. For example, the repeater 605 and/or the repeater 610 may receive the configuration information via the PCell. In some aspects, the PCell may be associated with a first frequency band, and the first carrier frequency and the second carrier frequency may be associated with a second frequency band. For example, the PCell may be associated with a lower frequency band than the SCell. Each repeater associated with the SCell may be configured with different (e.g., multiple) carrier frequencies that are included in the second frequency band (e.g., a higher frequency band than the first frequency band).

The repeater 605 and/or the repeater 610 may be configured based at least in part on the reported capabilities of the repeater 605 and/or the repeater 610. For example, the repeater 605 and/or the repeater 610 may be configured based at least in part on receiving the configuration information (e.g., from the network node 110). For example, the repeater 605 and/or the repeater 610 may be configured to use different carrier frequencies for the same SCell and/or the same CC based at least in part on reporting a capability indicating support for using the different frequencies. In some aspects, the repeater 605 and/or the repeater 610 may be configured to use carrier frequencies that are included in a reported range of supported carrier frequencies. For example, the repeater 605 and/or the repeater 610 may be configured different carrier frequency configurations for different Tx/Rx sides and/or different links via OOB control over the PCell during an installation procedure of the repeater 605 and/or the repeater 610. The configurations may be conditioned and/or be based at least in part on the reported capabilities of the repeaters (e.g., as described in connection with reference numbers 615 and 620).

The UE 120 may receive first configuration information associated with the SCell indicating a first carrier frequency associated with the SCell. The first configuration information may be included in an RRC communication. The first carrier frequency may be associated with a first coverage area of the SCell. The first carrier frequency may be associated with the repeater 605. For example, the first carrier frequency may be a carrier frequency configured for the repeater 605 to use for a link to UEs included in the coverage area served by the repeater 605. As described elsewhere herein, the repeater 605 may use a different carrier frequency for another link or hop (e.g., to the repeater 610 or the network node 110). In some aspects, the UE 120 may receive second configuration information associated with the SCell indicating a second carrier frequency associated with the SCell. For example, the UE 120 may be configured to use different carrier frequencies for different coverage areas and/or different repeaters associated with the SCell. In some aspects, the UE 120 may receive the second configuration information based at least in part on a location of the UE 120 changing from the first coverage area to a second coverage area of the SCell. In other words, as the UE 120 moves from the first coverage area to the second coverage area, the UE 120 may receive a different carrier frequency configuration.

In some aspects, the UE 120 may receive an RRC configuration (e.g., from the network node 110 and/or via the PCell) indicating multiple carrier frequencies associated with the SCell. In some aspects, the RRC configuration may be included in the configuration information (e.g., transmitted by the network node 110 as described above). In other aspects, the RRC configuration may be included in a separate communication from the configuration information. For example, the multiple carrier frequencies may be carrier frequencies configured (e.g., via the configuration information) for the repeater 605 and/or for the repeater 610. The multiple carrier frequencies may be possible or available frequencies for the SCell. The UE 120 may receive an indication of a carrier frequency, from the multiple carrier frequencies, to be used for the SCell based at least in part on a coverage area in which the UE 120 is located. For example, after the UE 120 moves from one coverage are to another coverage area, the UE 120 may receive a different carrier frequency configuration from the carrier frequency options indicated for the SCell (e.g., that are RRC configured for the UE 120). For example, in some aspects, the UE 120 may be configured to use a given carrier frequency for the SCell after the UE 120 has moved within a given coverage area or coverage spot of the SCell. After the UE 120 moves to a different coverage area or a different coverage spot, the UE 120 may receive an indication of a second carrier frequency to be used for the SCell.

In some aspects, the UE 120 may receive the indication(s) of the carrier frequency to be used for the SCell via one or more RRC communications via the PCell. As another example, the UE 120 may receive an indication of multiple carrier frequencies associated with the SCell via an RRC communication and via the PCell. The UE 120 may receive an indication of a carrier frequency, from the multiple carrier frequencies, via another RRC communication, a MAC-CE communication, a DCI communication, and/or another type of communication via the PCell (e.g., based at least in part on moving into a coverage area of a repeater configured to use the carrier frequency).

In some aspects, the UE 120 may receive the second configuration information as part of an activation procedure of a link associated with the second coverage area. For example, the network node 110 may activate the repeater 610 and/or an SCell link associated with the repeater 610. As part of the activation, the UE 120 may receive an indication of the carrier frequency to be associated with the second coverage area and/or the repeater 610.

In some aspects, the UE 120 may receive a dynamic indication of the carrier frequency to be used for the SCell. For example, for a coverage area that is collocated with a coverage area of the network node 110 (e.g., where the network node 110 or a device collocated with the network node 110 serves the coverage area), the UE 120 may be configured with different carrier frequencies for the SCell dynamically. For example, different links associated with the SCell may be frequency division multiplexed by the network node 110. For example, the network node 110 may support a higher overall bandwidth for the SCell than a supported bandwidth of a repeater (e.g., the repeater 605 and/or the repeater 610) and/or of the UE 120. In such examples, the network node 110 may frequency division multiplex different links associated with the SCell to take advantage of the larger supported bandwidth.

As shown by reference number 630, the network node 110 and the repeater 605 may communicate (e.g., transmit and/or receive) one or more signals using a first carrier frequency (e.g., first frequency). For example, the repeater 605 may be configured to use the first carrier frequency for a link or hop between the network node 110 and the repeater 605. For example, the network node 110 may communicate with the repeater 605 via a donor link or a backhaul link. In some aspects, the network node 110 may transmit, and the repeater 605 may receive, one or more signals. The one or more signals may be associated with a communication (e.g., that is intended for the UE 120). As another example, the repeater 605 may transmit, and the network node 110 may receive, one or more signals associated with a communication (e.g., that is originally transmitted by the UE 120 and that is intended for the network node 110). For example, the repeater 605 may receive, using the first carrier frequency, a first one or more signals associated with the SCell.

As shown by reference number 635, the repeater 605 and the UE 120 may communicate (e.g., transmit and/or receive) one or more signals using a second carrier frequency. For example, the repeater 605 may transmit, using the second carrier frequency, a second one or more signals, the second one or more signals being associated with an analog repeating operation of a first one or more signals received from the network node 110. For example, the second one or more signals may be repeated signals. As another example, the repeater 605 may receive, using the second carrier frequency, the second one or more signals and may amplify and forward (e.g., after converting the carrier frequency to the first carrier frequency) the first one or more signals to the network node 110 or to another repeater, such as the repeater 610. In such examples, the first one or more signals may be repeated signals.

For example, the repeater 605 may receive the first one or more signals from the network node 110. The repeater 605 may receive the first one or more signals using the first carrier frequency. The repeater 605 may process (e.g., in the analog domain) the first one or more signals to obtain the second one or more signals. For example, processing the first one or more signals may include converting the first carrier frequency to the second carrier frequency. The repeater 605 may transmit, to the UE 120, the second one or more signals using the second carrier frequency as part of an analog repeating operation. As another example, the repeater 605 may receive the second one or more signals from the UE 120 using the second carrier frequency. The repeater 605 may process (e.g., in the analog domain) the second one or more signals to obtain the first one or more signals. For example, processing the second one or more signals may include converting the second carrier frequency to the first carrier frequency. The repeater 605 may transmit, to the network node 110, the first one or more signals using the first carrier frequency as part of an analog repeating operation. In some aspects, the analog repeating operation may be associated with intra-band carrier aggregation. For example, the first carrier frequency and the second carrier frequency may be included in the same frequency band (e.g., a sub-THz frequency band).

In some aspects, the UE 120 may move (e.g., a physical location of the UE 120 may change) from a first coverage area of the SCell (e.g., that is associated with the repeater 605) to a second coverage area of the SCell (e.g., that is associated with the repeater 610). For example, different repeaters, such as the repeater 605 and the repeater 610, may serve different coverage areas of the same SCell. The different repeaters may be configured to use different (e.g., multiple) carrier frequencies for the SCell. For example, as described in more detail elsewhere herein, the repeater may use different carrier frequencies (e.g., from a sub-THz frequency band) for transmitting and receiving operations to improve a Tx-to-Rx isolation of the repeater. Therefore, in some cases, the UE 120 may communicate via the SCell using different carrier frequencies depending on a coverage area in which the UE 120 is located. For example, in some cases, different repeaters may use the same carrier frequency to communicate with UEs, such as the UE 120 (e.g., and different carrier frequencies for another hop or link associated with the different repeaters). In other cases, different repeaters may use different carrier frequencies to communicate with UEs, such as the UE 120.

For example, as shown by reference number 640, the network node 110 and the repeater 610 may communicate (e.g., transmit and/or receive) one or more signals using a third carrier frequency (e.g., third frequency). For example, the repeater 610 may be configured to use the third carrier frequency for a link or hop between the network node 110 and the repeater 610. For example, the network node 110 may communicate with the repeater 610 via a donor link or a backhaul link. In some aspects, the network node 110 may transmit, and the repeater 610 may receive, one or more signals. The one or more signals may be associated with a communication (e.g., that is intended for the UE 120). As another example, the repeater 610 may transmit, and the network node 110 may receive, one or more signals associated with a communication (e.g., that is originally transmitted by the UE 120 and that is intended for the network node 110). For example, the repeater 610 may receive, using the third carrier frequency, a first one or more signals associated with the SCell. In some aspects, the third carrier frequency may be the first carrier frequency (e.g., that is used for a link between the network node 110 and the repeater 605). In other example, the third carrier frequency and the first carrier frequency may be different frequencies.

As shown by reference number 645, the repeater 610 and the UE 120 may communicate (e.g., transmit and/or receive) one or more signals using a fourth carrier frequency. For example, the repeater 610 may transmit, using the fourth carrier frequency, one or more signals, the one or more signals being associated with an analog repeating operation of a first one or more signals received from the network node 110. For example, the one or more signals may be repeated signals. As another example, the repeater 610 may receive, using the fourth carrier frequency, the one or more signals and may amplify and forward (e.g., after converting the carrier frequency to the third carrier frequency) the one or more signals to the network node 110 or to another repeater, such as the repeater 605. The fourth carrier frequency may be different than the second carrier frequency (e.g., that is used for a coverage area of the SCell associated with the repeater 605). For example, the fourth carrier frequency may be configured (e.g., via the network node 110 and the PCell) for the coverage area of the SCell that is associated with the repeater 610.

For example, the repeater 610 may receive one or more signals from the network node 110. The repeater 610 may receive the one or more signals using the third carrier frequency. The repeater 610 may process (e.g., in the analog domain) the one or more signals to obtain a second one or more signals. For example, processing the one or more signals may include converting the third carrier frequency to the fourth carrier frequency. The repeater 610 may transmit, to the UE 120, the second one or more signals using the fourth carrier frequency as part of an analog repeating operation. As another example, the repeater 610 may receive the second one or more signals from the UE 120 using the fourth carrier frequency. The repeater 610 may process (e.g., in the analog domain) the second one or more signals to obtain the one or more signals. For example, processing the second one or more signals may include converting the fourth carrier frequency to the third carrier frequency. The repeater 610 may transmit, to the network node 110, the one or more signals using the third carrier frequency as part of an analog repeating operation. In some aspects, the analog repeating operation may be associated with intra-band carrier aggregation. For example, the third carrier frequency and the fourth carrier frequency may be included in the same frequency band (e.g., a sub-THz frequency band).

In some aspects, the second carrier frequency and the fourth carrier frequency (e.g., that are associated with the different coverage areas of the SCell) may be included in the same frequency band (e.g., a sub-THz frequency band). The first carrier frequency and the third carrier frequency may be the same carrier frequency and/or may be included in the same frequency band (e.g., an FR1 frequency band, an FR2 frequency band, and/or an FR4 frequency band). For example, the second carrier frequency and the fourth carrier frequency may be associated with a first frequency band and the first carrier frequency, and the third carrier frequency may be associated with a second frequency band. In other examples, the first carrier frequency, the second carrier frequency, the third carrier frequency, and the fourth carrier frequency may be associated with the same frequency band.

In some aspects, a link between the UE 120 and the network node 110 may include multiple hops (e.g., associated with multiple repeaters). In such examples, multiple carrier frequencies may be used for the multi-hop link. For example, two carrier frequencies may be used for the multi-hop link (e.g., two carrier frequencies from the same frequency band) and the different hops may alternate between the two carrier frequencies. For example, a first hop may use frequency 1, a second hop may use a frequency 2, a third hop may use the frequency 1, and so on. This may enable repeaters to use different carrier frequencies for different hops and/or links, thereby improving a Tx-to-Rx isolation of the repeaters. In other examples, more than two carrier frequencies may be used for a multi-hop link.

As a result, the repeater may mitigate noise or interference caused by Tx-to-Rx leakage. For example, different carrier frequencies may be used on different sides of an analog repeater (Tx and Rx) to increase Tx to Rx isolation based on frequency domain separation. Frequency domain-based separation of Tx and Rx signals on the repeater side allows to avoid nonstable and/or resonating power loops. Additionally, by enabling a repeater, such as the repeater 605 and/or the repeater 610, to use different frequencies and/or different frequencies bands for a repeating operation, a transmit power (e.g., an allowed transmit power) of the repeater may be increased. For example, the repeater may use a larger amplification factor for analog repeating operations associated with the network deployment. This may improve a range and/or coverage area of the repeater. By increasing the range and/or coverage area of the repeater, a range and/or coverage area of a sub-THz network deployment (such as the network deployment depicted in FIG. 5) may be increased. Further, increasing the amplification factor used by the repeater may increase a throughput of the multi-hop link. By increasing Tx to Rx isolation at repeaters (e.g., by enabling the repeaters to use different carrier frequencies), an EVM of different hops of a multi-hop link may be improved (e.g., because the EVM may not be limited by in-channel Tx to Rx leaking of the repeaters).

Additionally, a multi-hop link configuration and activation procedure may be simplified because different hops of the multi-hop link that use different carrier frequencies and/or sub-bands may be addressed as the same SCell. For example, the network (e.g., a network node) may be enabled to configure the different coverage areas to use different carrier frequencies under the same SCell configuration, thereby simplifying the configuration and/or activation of the coverage areas (e.g., as compared to configuring different SCell configurations for each different carrier frequency). Further, the network node may be enabled to co-schedule different UEs (e.g., accessing an SCell using different repeaters and/or coverage areas) that share one or more common hops of a multi-hop link (e.g., to the network node 110).

As indicated above, FIG. 6 is provided as an example. Other examples may differ from what is described with regard to FIG. 6.

FIG. 7 is a diagram of an example 700 associated with different carrier frequencies for SCell coverage, in accordance with the present disclosure. As shown in FIG. 7, the network node 110 (e.g., a base station, a CU, a DU, and/or an RU) may communicate with the UE 120 via one or more repeaters, such as the repeater 605 and/or the repeater 610.

As shown in FIG. 7, the repeater 605 may serve a first coverage area of an SCell (e.g., SCell coverage area 1 as shown in FIG. 7). The repeater 610 may serve a second coverage area of the same SCell (e.g., SCell coverage area 2 as shown in FIG. 7). The UE 120, the repeater 605, and/or the repeater 610 may communicate with the network node 110 via a PCell link. For example, the UE 120, the repeater 605, and/or the repeater 610 may establish a PCell connection with the network node 110. The UE 120 may connect with the SCell (e.g., at a coverage area via the repeater 605 or the repeater 610) to increase throughput associated with the UE 120.

In some cases, different coverage areas of the SCell may be associated with different carrier frequencies. For example, UEs communicating via the first coverage area (e.g., via the repeater 605) may communicate via the SCell using a first carrier frequency (e.g., frequency 1 as shown in FIG. 7). UEs communicating via the second coverage area (e.g., via the repeater 610) may communicate via the SCell using a second carrier frequency (e.g., frequency 2 as shown in FIG. 7). The first carrier frequency and the second carrier frequency may be different frequencies included in the same frequency band (e.g., a sub-THz frequency band). For example, a UE 120 that moves from the first coverage area to the second coverage area may be configured to use a different carrier frequency to communicate via the SCell.

For example, a configuration of the SCell may configure each of the coverage areas with different carrier frequencies via the same configuration. For example, a multi-hop link configuration and/or activation procedure may be simplified because different hops or links of the multi-hop link (e.g., different coverage areas) that use different carrier frequencies may be addressed and/or configured using the same SCell and/or the same virtual component carrier (e.g., a virtual component carrier may be a logical component carrier that is associated with multiple carrier frequencies).

In some aspects, the repeater 605 and/or the repeater 610 may communicate with the network node 110 via one or more other repeaters (e.g., in a similar manner as depicted in FIG. 5). In some aspects, the repeater 605 and the repeater 610 may communicate with the network node 110 via the same repeater (e.g., via the same AP). In such examples, the network node 110 may co-schedule UEs included in the first coverage area and the second coverage area. For example, because of the shared link to the network node 110 (e.g., via the same repeater and/or AP), the network node 110 may be enabled to co-schedule different UEs having SCell access using different coverage areas and/or different repeaters because of the common link(s) to the network node 110. This simplifies scheduling for the network deployment depicted in FIG. 7.

Usage of different carrier frequencies for Rx/Tx sides of the repeaters results in an improved Tx-to-Rx isolation (forwarded signal leakage from Tx side to Rx side of the same repeater) based on frequency domain separation that mitigates non-stable behavior at the Rx-Tx amplify and forward analog path of the repeater. When different Tx and Rx frequencies are used by an analog repeater, the Tx-to-Rx leakage issue is relaxed because in such examples case only low noise amplifier (LNA) saturation may be the main limiting factor of an amplification factor that can be applied by the repeater (e.g., because Tx power may leak into the LNA in addition to an Rx signal). To mitigate the LNA saturation, a bandpass filter may be used by the repeater before the LNA in a processing path to separate Tx frequencies from Rx frequencies. Using different carrier frequencies for Rx/Tx sides of the repeater enables improved bandpass filtering, and thereby reducing a likelihood of LNA saturation. Correspondingly, a higher forwarding amplification can be used on by the repeater, resulting in an increase of a range of the repeater and/or an increase of a size of the coverage area associated with the repeater.

As indicated above, FIG. 7 is provided as an example. Other examples may differ from what is described with regard to FIG. 7.

FIG. 8 is a diagram illustrating an example process 800 performed, for example, by a UE, in accordance with the present disclosure. Example process 800 is an example where the UE (e.g., UE 120) performs operations associated with different carrier frequencies for SCell coverage.

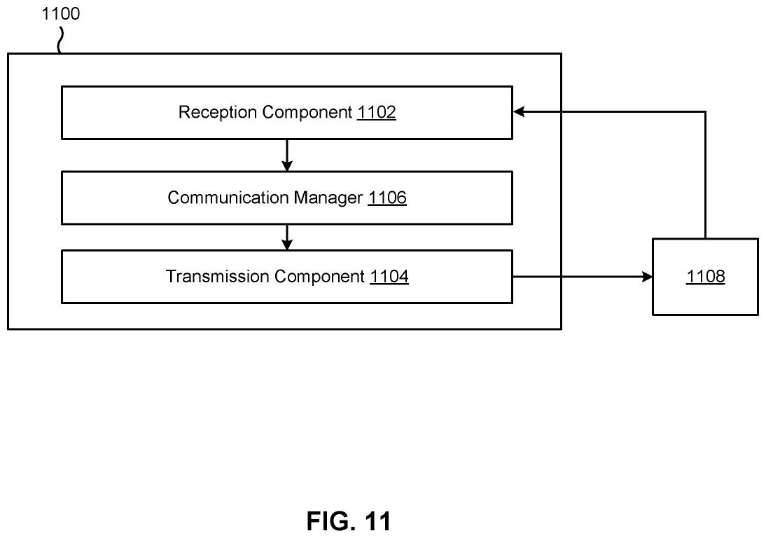

As shown in FIG. 8, in some aspects, process 800 may include receiving, from a network node and via a primary cell, first configuration information associated with a secondary cell indicating a first carrier frequency associated with the secondary cell, the first carrier frequency being associated with a first coverage area of the secondary cell (block 810). For example, the UE (e.g., using communication manager 1106 and/or reception component 1102, depicted in FIG. 11) may receive, from a network node and via a primary cell, first configuration information associated with a secondary cell indicating a first carrier frequency associated with the secondary cell, the first carrier frequency being associated with a first coverage area of the secondary cell, as described in connection with FIGS. 6 and 7.

As further shown in FIG. 8, in some aspects, process 800 may include communicating, via the secondary cell, a first one or more signals using the first carrier frequency (block 820). For example, the UE (e.g., using communication manager 1106, reception component 1102, and/or transmission component 1104, depicted in FIG. 11) may communicate, via the secondary cell, a first one or more signals using the first carrier frequency, as described in connection with FIGS. 6 and 7.

As further shown in FIG. 8, in some aspects, process 800 may include receiving, from the network node and via the primary cell, second configuration information associated with the secondary cell indicating a second carrier frequency associated with the secondary cell based at least in part on a location of the UE changing from the first coverage area to a second coverage area of the secondary cell (block 830). For example, the UE (e.g., using communication manager 1106 and/or reception component 1102, depicted in FIG. 11) may receive, from the network node and via the primary cell, second configuration information associated with the secondary cell indicating a second carrier frequency associated with the secondary cell based at least in part on a location of the UE changing from the first coverage area to a second coverage area of the secondary cell, as described in connection with FIGS. 6 and 7.

As further shown in FIG. 8, in some aspects, process 800 may include communicating, via the secondary cell, a second one or more signals using the second carrier frequency (block 840). For example, the UE (e.g., using communication manager 140, reception component 1102, and/or transmission component 1104, depicted in FIG. 11) may communicate, via the secondary cell, a second one or more signals using the second carrier frequency, as described in connection with FIGS. 6 and 7.

Process 800 may include additional aspects, such as any single aspect or any combination of aspects described below and/or in connection with one or more other processes described elsewhere herein.

In a first aspect, communicating the first one or more signals using the first carrier frequency includes communicating the first one or more signals via a first repeater associated with the secondary cell, and communicating the second one or more signals using the second carrier frequency includes communicating the second one or more signals via a second repeater associated with the secondary cell.

In a second aspect, alone or in combination with the first aspect, the primary cell is associated with a first frequency band, and wherein the first carrier frequency and the second carrier frequency are associated with a second frequency band.

In a third aspect, alone or in combination with one or more of the first and second aspects, the first configuration information and the second configuration information are included in one or more radio resource control communications.

In a fourth aspect, alone or in combination with one or more of the first through third aspects, the first configuration information and the second configuration information are included in a single communication, and process 800 includes switching from operating using the first carrier frequency to the second carrier frequency based at least in part on detecting that the location of the UE has changed from the first coverage area to the second coverage area. For example, in some aspects, the UE may be configured with different carrier frequencies for the secondary cell based at least in part on a coverage area in which the UE is located.

In a fifth aspect, alone or in combination with one or more of the first through fourth aspects, receiving the second configuration information includes receiving the second configuration information as part of an activation procedure of a link associated with the second coverage area.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a repeater, in accordance with the present disclosure. Example process 900 is an example where the repeater (e.g., the repeater 605, the repeater 610, a network node 110, and/or a UE 120) performs operations associated with different carrier frequencies SCell coverage.

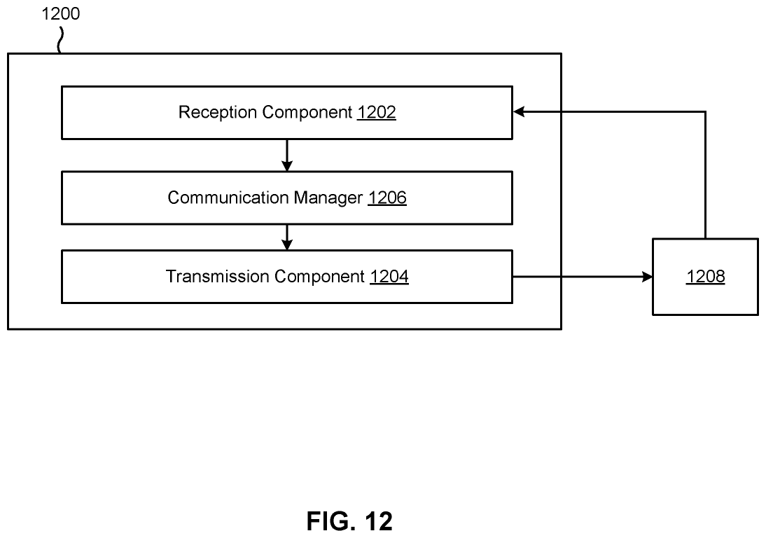

As shown in FIG. 9, in some aspects, process 900 may include receiving, from a network node and via a primary cell, configuration information for a secondary cell, the configuration information indicating a first carrier frequency and a second carrier frequency to be used for the secondary cell, the first carrier frequency and the second carrier frequency being included in a frequency band (block 910). For example, the repeater (e.g., using communication manager 1206 and/or reception component 1202, depicted in FIG. 12) may receive, from a network node and via a primary cell, configuration information for a secondary cell, the configuration information indicating a first carrier frequency and a second carrier frequency to be used for the secondary cell, the first carrier frequency and the second carrier frequency being included in a frequency band, as described in connection with FIGS. 6 and 7.

As further shown in FIG. 9, in some aspects, process 900 may include receiving, via the first carrier frequency, a first one or more signals associated with the secondary cell (block 920). For example, the repeater (e.g., using communication manager 1206 and/or reception component 1202, depicted in FIG. 12) may receive, via the first carrier frequency, a first one or more signals associated with the secondary cell, as described in connection with FIGS. 6 and 7.

As further shown in FIG. 9, in some aspects, process 900 may include transmitting, via the second carrier frequency, a second one or more signals, the second one or more signals being associated with an analog repeating operation of the first one or more signals (block 930). For example, the repeater (e.g., using communication manager 1206 and/or transmission component 1204, depicted in FIG. 12) may transmit, via the second carrier frequency, a second one or more signals, the second one or more signals being associated with an analog repeating operation of the first one or more signals, as described in connection with FIGS. 6 and 7. For example, the repeater may use different carrier frequencies for a first link associated with the SCell (e.g., between the repeater and a UE) and a second link associated with the SCell (e.g., between the repeater and a network node or another repeater).

Process 900 may include additional aspects, such as any single aspect or any combination of aspects described below and/or in connection with one or more other processes described elsewhere herein.

In a first aspect, process 900 includes transmitting, to the network node, a capability communication indicating that the repeater supports using different carrier frequencies for the secondary cell.

In a second aspect, alone or in combination with the first aspect, the capability communication indicates a range of frequencies supported for using different carrier frequencies for the secondary cell, the range of frequencies including the first carrier frequency and the second carrier frequency.

In a third aspect, alone or in combination with one or more of the first and second aspects, the capability communication indicates a supported transmit power amplification associated with using different carrier frequencies for the secondary cell during the analog repeating operation.

In a fourth aspect, alone or in combination with one or more of the first through third aspects, process 900 includes processing the first one or more signals to obtain the second one or more signals, wherein processing the first one or more signals includes converting the first carrier frequency to the second carrier frequency.

In a fifth aspect, alone or in combination with one or more of the first through fourth aspects, the analog repeating operation is associated with intra-band carrier aggregation.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network node, in accordance with the present disclosure. Example process 1000 is an example where the network node (e.g., network node 110) performs operations associated with different carrier frequencies for SCell coverage.

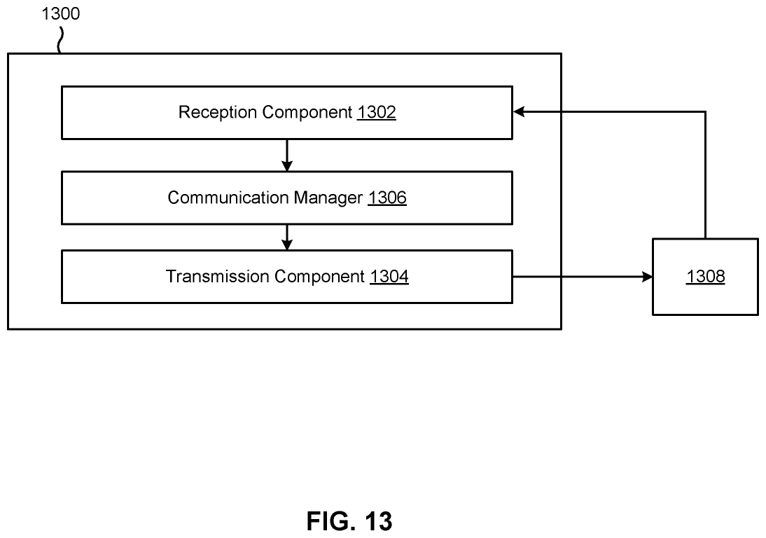

As shown in FIG. 10, in some aspects, process 1000 may include transmitting first configuration information, for a repeater, associated with a secondary cell, the first configuration information indicating a first carrier frequency and a second carrier frequency to be used for the secondary cell, the first configuration information indicating that the repeater is to use the first carrier frequency for receiving operations and the second carrier frequency for transmitting operations, and the first carrier frequency and the second carrier frequency being included in a frequency band (block 1010). For example, the network node (e.g., using communication manager 1306 and/or transmission component 1304, depicted in FIG. 13) may transmit first configuration information, for a repeater, associated with a secondary cell, the first configuration information indicating a first carrier frequency and a second carrier frequency to be used for the secondary cell, the first configuration information indicating that the repeater is to use the first carrier frequency for receiving operations and the second carrier frequency for transmitting operations, and the first carrier frequency and the second carrier frequency being included in a frequency band, as described in connection with FIGS. 6 and 7.

As further shown in FIG. 10, in some aspects, process 1000 may include transmitting second configuration information, for a UE, associated with the secondary cell, the second configuration information indicating a first operating frequency, from the first carrier frequency or the second carrier frequency, for the secondary cell (block 1020). For example, the network node (e.g., using communication manager 1306 and/or transmission component 1304, depicted in FIG. 13) may transmit second configuration information, for a UE, associated with the secondary cell, the second configuration information indicating a first operating frequency, from the first carrier frequency or the second carrier frequency, for the secondary cell, as described in connection with FIGS. 6 and 7.

Process 1000 may include additional aspects, such as any single aspect or any combination of aspects described below and/or in connection with one or more other processes described elsewhere herein.

In a first aspect, process 1000 includes receiving a capability communication associated with the repeater indicating that the repeater supports using different carrier frequencies for the secondary cell.

In a second aspect, alone or in combination with the first aspect, the capability communication indicates a range of frequencies supported for using different carrier frequencies for the secondary cell, the range of frequencies including the first carrier frequency and the second carrier frequency.

In a third aspect, alone or in combination with one or more of the first and second aspects, the capability communication indicates a supported transmit power amplification associated with using different carrier frequencies during an analog repeating operation for the secondary cell.

In a fourth aspect, alone or in combination with one or more of the first through third aspects, the repeater is an analog repeater associated with a coverage area of the secondary cell.

In a fifth aspect, alone or in combination with one or more of the first through fourth aspects, the second configuration information is associated with a first coverage area of the secondary cell, and process 1000 includes transmitting third configuration information, for the UE, indicating a second operating frequency, from the first carrier frequency, the second carrier frequency, or a third carrier frequency, for the secondary cell.

In a sixth aspect, alone or in combination with one or more of the first through fifth aspects, the first operating frequency is associated with the first coverage area of the secondary cell, and the second operating frequency is associated with a second coverage area of the secondary cell.

In a seventh aspect, alone or in combination with one or more of the first through sixth aspects, the first operating frequency is associated with a transmitting frequency of the repeater, and the second operating frequency is associated with another transmitting frequency of another repeater associated with the secondary cell.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108 (such as a UE, a network node, a base station, or another wireless communication device) using the reception component 1102 and the transmission component 1104.

In some aspects, the apparatus 1100 may be configured to perform one or more operations described herein in connection with FIGS. 6 and 7. Additionally, or alternatively, the apparatus 1100 may be configured to perform one or more processes described herein, such as process 800 of FIG. 8, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The reception component 1102 may receive, from a network node and via a primary cell, first configuration information associated with a secondary cell indicating a first carrier frequency associated with the secondary cell, the first carrier frequency being associated with a first coverage area of the secondary cell. The reception component 1102 and/or the transmission component 1104 may communicate, via the secondary cell, a first one or more signals using the first carrier frequency. The reception component 1102 may receive, from the network node and via the primary cell, second configuration information associated with the secondary cell indicating a second carrier frequency associated with the secondary cell based at least in part on a location of the UE changing from the first coverage area to a second coverage area of the secondary cell. The reception component 1102 and/or the transmission component 1104 may communicate, via the secondary cell, a second one or more signals using the second carrier frequency.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a repeater, or a repeater may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 160 described in connection with FIG. 1. As shown, the apparatus 1200 may communicate with another apparatus 1208 (such as a UE, a base station, or another wireless communication device) using the reception component 1202 and the transmission component 1204.

In some aspects, the apparatus 1200 may be configured to perform one or more operations described herein in connection with FIGS. 6 and 7. Additionally, or alternatively, the apparatus 1200 may be configured to perform one or more processes described herein, such as process 900 of FIG. 9, or a combination thereof. In some aspects, the apparatus 1200 and/or one or more components shown in FIG. 12 may include one or more components of the repeater described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the repeater described in connection with FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, a modem, a modulator, a transmit MIMO processor, a transmit processor, a controller/processor, a memory, or a combination thereof, of the repeater described in connection with FIG. 2. In some aspects, the transmission component 1204 may be co-located with the reception component 1202 in a transceiver.

The reception component 1202 may receive, from a network node and via a primary cell, configuration information for a secondary cell, the configuration information indicating a first carrier frequency and a second carrier frequency to be used for the secondary cell, the first carrier frequency and the second carrier frequency being included in a frequency band. The reception component 1202 may receive, via the first carrier frequency, a first one or more signals associated with the secondary cell. The transmission component 1204 may transmit, via the second carrier frequency, a second one or more signals, the second one or more signals being associated with an analog repeating operation of the first one or more signals.

The transmission component 1204 may transmit, to the network node, a capability communication indicating that the repeater supports using different carrier frequencies for the secondary cell.

The communication manager 1206 may process the first one or more signals to obtain the second one or more signals, wherein processing the first one or more signals includes converting the first carrier frequency to the second carrier frequency.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 150 described in connection with FIG. 1. As shown, the apparatus 1300 may communicate with another apparatus 1308 (such as a UE, a base station, or another wireless communication device) using the reception component 1302 and the transmission component 1304.

In some aspects, the apparatus 1300 may be configured to perform one or more operations described herein in connection with FIGS. 6 and 7. Additionally, or alternatively, the apparatus 1300 may be configured to perform one or more processes described herein, such as process 1000 of FIG. 10, or a combination thereof. In some aspects, the apparatus 1300 and/or one or more components shown in FIG. 13 may include one or more components of the network node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network node described in connection with FIG. 2.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, a modem, a modulator, a transmit MIMO processor, a transmit processor, a controller/processor, a memory, or a combination thereof, of the network node described in connection with FIG. 2. In some aspects, the transmission component 1304 may be co-located with the reception component 1302 in a transceiver.

The transmission component 1304 may transmit first configuration information, for a repeater, associated with a secondary cell, the first configuration information indicating a first carrier frequency and a second carrier frequency to be used for the secondary cell, the first configuration information indicating that the repeater is to use the first carrier frequency for receiving operations and the second carrier frequency for transmitting operations, and the first carrier frequency and the second carrier frequency being included in a frequency band. The transmission component 1304 may transmit second configuration information, for a UE, associated with the secondary cell, the second configuration information indicating a first operating frequency, from the first carrier frequency or the second carrier frequency, for the secondary cell.

The reception component 1302 may receive a capability communication associated with the repeater indicating that the repeater supports using different carrier frequencies for the secondary cell.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by user equipment (UE), comprising: receiving, from a network node and via a primary cell, first configuration information associated with a secondary cell indicating a first carrier frequency associated with the secondary cell, the first carrier frequency being associated with a first coverage area of the secondary cell; communicating, via the secondary cell, a first one or more signals using the first carrier frequency; receiving, from the network node and via the primary cell, second configuration information associated with the secondary cell indicating a second carrier frequency associated with the secondary cell based at least in part on a location of the UE changing from the first coverage area to a second coverage area of the secondary cell; and communicating, via the secondary cell, a second one or more signals using the second carrier frequency.

Aspect 2: The method of Aspect 1, wherein communicating the first one or more signals using the first carrier frequency comprises: communicating the first one or more signals via a first repeater associated with the secondary cell; and wherein communicating the second one or more signals using the second carrier frequency comprises: communicating the second one or more signals via a second repeater associated with the secondary cell.

Aspect 3: The method of any of Aspects 1-2, wherein the primary cell is associated with a first frequency band, and wherein the first carrier frequency and the second carrier frequency are associated with a second frequency band.

Aspect 4: The method of any of Aspects 1-3, wherein the first configuration information and the second configuration information are included in one or more radio resource control communications.

Aspect 5: The method of any of Aspects 1-4, wherein the first configuration information and the second configuration information are included in a single communication, the method further comprising: switching from operating using the first carrier frequency to the second carrier frequency based at least in part on detecting that the location of the UE has changed from the first coverage area to the second coverage area.

Aspect 6: The method of any of Aspects 1-5, wherein receiving the second configuration information comprises: receiving the second configuration information as part of an activation procedure of a link associated with the second coverage area.

Aspect 7: A method of wireless communication performed by a repeater, comprising: receiving, from a network node and via a primary cell, configuration information for a secondary cell, the configuration information indicating a first carrier frequency and a second carrier frequency to be used for the secondary cell, the first carrier frequency and the second carrier frequency being included in a frequency band; receiving, via the first carrier frequency, a first one or more signals associated with the secondary cell; and transmitting, via the second carrier frequency, a second one or more signals, the second one or more signals being associated with an analog repeating operation of the first one or more signals.

Aspect 8: The method of Aspect 7, further comprising: transmitting, to the network node, a capability communication indicating that the repeater supports using different carrier frequencies for the secondary cell.

Aspect 9: The method of Aspect 8, wherein the capability communication indicates a range of frequencies supported for using different carrier frequencies for the secondary cell, the range of frequencies including the first carrier frequency and the second carrier frequency.

Aspect 10: The method of Aspect 8, wherein the capability communication indicates a supported transmit power amplification associated with using different carrier frequencies for the secondary cell during the analog repeating operation.

Aspect 11: The method of any of Aspects 7-10, further comprising: processing the first one or more signals to obtain the second one or more signals, wherein processing the first one or more signals includes converting the first carrier frequency to the second carrier frequency.

Aspect 12: The method of any of Aspects 7-11, wherein the analog repeating operation is associated with intra-band carrier aggregation.

Aspect 13: A method of wireless communication performed by a network node, comprising: transmitting first configuration information, for a repeater, associated with a secondary cell, the first configuration information indicating a first carrier frequency and a second carrier frequency to be used for the secondary cell, the first configuration information indicating that the repeater is to use the first carrier frequency for receiving operations and the second carrier frequency for transmitting operations, and the first carrier frequency and the second carrier frequency being included in a frequency band; and transmitting second configuration information, for a user equipment (UE), associated with the secondary cell, the second configuration information indicating a first operating frequency, from the first carrier frequency or the second carrier frequency, for the secondary cell.

Aspect 14: The method of Aspect 13, further comprising: receiving a capability communication associated with the repeater indicating that the repeater supports using different carrier frequencies for the secondary cell.

Aspect 15: The method of Aspect 14, wherein the capability communication indicates a range of frequencies supported for using different carrier frequencies for the secondary cell, the range of frequencies including the first carrier frequency and the second carrier frequency.

Aspect 16: The method of Aspect 14, wherein the capability communication indicates a supported transmit power amplification associated with using different carrier frequencies during an analog repeating operation for the secondary cell.

Aspect 17: The method of any of Aspects 13-16, wherein the repeater is an analog repeater associated with a coverage area of the secondary cell.

Aspect 18: The method of any of Aspects 13-17, wherein the second configuration information is associated with a first coverage area of the secondary cell, the method further comprising: transmitting third configuration information, for the UE, indicating a second operating frequency, from the first carrier frequency, the second carrier frequency, or a third carrier frequency, for the secondary cell.

Aspect 19: The method of Aspect 18, wherein the first operating frequency is associated with the first coverage area of the secondary cell, and wherein the second operating frequency is associated with a second coverage area of the secondary cell.

Aspect 20: The method of Aspect 18, wherein the first operating frequency is associated with a transmitting frequency of the repeater, and wherein the second operating frequency is associated with another transmitting frequency of another repeater associated with the secondary cell.

Aspect 21: An apparatus for wireless communication at a device, comprising a processor; memory coupled with the processor; and instructions stored in the memory and executable by the processor to cause the apparatus to perform the method of one or more of Aspects 1-6.

Aspect 22: A device for wireless communication, comprising a memory and one or more processors coupled to the memory, the one or more processors configured to perform the method of one or more of Aspects 1-6.

Aspect 23: An apparatus for wireless communication, comprising at least one means for performing the method of one or more of Aspects 1-6.

Aspect 24: A non-transitory computer-readable medium storing code for wireless communication, the code comprising instructions executable by a processor to perform the method of one or more of Aspects 1-6.

Aspect 25: A non-transitory computer-readable medium storing a set of instructions for wireless communication, the set of instructions comprising one or more instructions that, when executed by one or more processors of a device, cause the device to perform the method of one or more of Aspects 1-6.

Aspect 26: An apparatus for wireless communication at a device, comprising a processor; memory coupled with the processor; and instructions stored in the memory and executable by the processor to cause the apparatus to perform the method of one or more of Aspects 7-12.

Aspect 27: A device for wireless communication, comprising a memory and one or more processors coupled to the memory, the one or more processors configured to perform the method of one or more of Aspects 7-12.

Aspect 28: An apparatus for wireless communication, comprising at least one means for performing the method of one or more of Aspects 7-12.

Aspect 29: A non-transitory computer-readable medium storing code for wireless communication, the code comprising instructions executable by a processor to perform the method of one or more of Aspects 7-12.

Aspect 30: A non-transitory computer-readable medium storing a set of instructions for wireless communication, the set of instructions comprising one or more instructions that, when executed by one or more processors of a device, cause the device to perform the method of one or more of Aspects 7-12.

Aspect 31: An apparatus for wireless communication at a device, comprising a processor; memory coupled with the processor; and instructions stored in the memory and executable by the processor to cause the apparatus to perform the method of one or more of Aspects 13-20.

Aspect 32: A device for wireless communication, comprising a memory and one or more processors coupled to the memory, the one or more processors configured to perform the method of one or more of Aspects 13-20.

Aspect 33: An apparatus for wireless communication, comprising at least one means for performing the method of one or more of Aspects 13-20.

Aspect 34: A non-transitory computer-readable medium storing code for wireless communication, the code comprising instructions executable by a processor to perform the method of one or more of Aspects 13-20.

Aspect 35: A non-transitory computer-readable medium storing a set of instructions for wireless communication, the set of instructions comprising one or more instructions that, when executed by one or more processors of a device, cause the device to perform the method of one or more of Aspects 13-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a +a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive, from a network node and via a primary cell, first configuration information associated with a secondary cell indicating a first carrier frequency associated with the secondary cell, the first carrier frequency being associated with a first coverage area of the secondary cell;
communicate, via the secondary cell, a first one or more signals using the first carrier frequency;
receive, from the network node and via the primary cell, second configuration information associated with the secondary cell indicating a second carrier frequency associated with the secondary cell based at least in part on a location of the UE changing from the first coverage area to a second coverage area of the secondary cell; and
communicate, via the secondary cell, a second one or more signals using the second carrier frequency.

2. The UE of claim 1, wherein the one or more processors, to communicate the first one or more signals using the first carrier frequency, are configured to:
communicate the first one or more signals via a first repeater associated with the secondary cell; and
wherein the one or more processors, to communicate the second one or more signals using the second carrier frequency, are configured to:
communicate the second one or more signals via a second repeater associated with the secondary cell.

3. The UE of claim 1, wherein the primary cell is associated with a first frequency band, and
wherein the first carrier frequency and the second carrier frequency are associated with a second frequency band.

4. The UE of claim 1, wherein the first configuration information and the second configuration information are included in one or more radio resource control communications.

5. The UE of claim 1, wherein the first configuration information and the second configuration information are included in a single communication, and wherein the one or more processors are further configured to:
switch from operating using the first carrier frequency to the second carrier frequency based at least in part on detecting that the location of the UE has changed from the first coverage area to the second coverage area.

6. The UE of claim 1, wherein the one or more processors, to receive the second configuration information, are configured to:
receive the second configuration information as part of an activation procedure of a link associated with the second coverage area.

7. A repeater for wireless communication, comprising:
a memory; and
one or more processors, coupled to the memory, configured to:
receive, from a network node and via a primary cell, configuration information for a secondary cell, the configuration information indicating a first carrier frequency and a second carrier frequency to be used for the secondary cell, the first carrier frequency and the second carrier frequency being included in a frequency band;
receive, via the first carrier frequency, a first one or more signals associated with the secondary cell; and
transmit, via the second carrier frequency, a second one or more signals, the second one or more signals being associated with an analog repeating operation of the first one or more signals.

8. The repeater of claim 7, wherein the one or more processors are further configured to:
transmit, to the network node, a capability communication indicating that the repeater supports using different carrier frequencies for the secondary cell.

9. The repeater of claim 8, wherein the capability communication indicates a range of frequencies supported for using different carrier frequencies for the secondary cell, the range of frequencies including the first carrier frequency and the second carrier frequency.

10. The repeater of claim 8, wherein the capability communication indicates a supported transmit power amplification associated with using different carrier frequencies for the secondary cell during the analog repeating operation.

11. The repeater of claim 7, wherein the one or more processors are further configured to:
process the first one or more signals to obtain the second one or more signals, wherein processing the first one or more signals includes converting the first carrier frequency to the second carrier frequency.

12. The repeater of claim 7, wherein the analog repeating operation is associated with intra-band carrier aggregation.

13. A network node for wireless communication, comprising:
a memory; and
one or more processors, coupled to the memory, configured to:
transmit first configuration information, for a repeater, associated with a secondary cell, the first configuration information indicating a first carrier frequency and a second carrier frequency to be used for the secondary cell, the first configuration information indicating that the repeater is to use the first carrier frequency for receiving operations and the second carrier frequency for transmitting operations, and the first carrier frequency and the second carrier frequency being included in a frequency band; and
transmit second configuration information, for a user equipment (UE), associated with the secondary cell, the second configuration information indicating a first operating frequency, from the first carrier frequency or the second carrier frequency, for the secondary cell.

14. The network node of claim 13, wherein the one or more processors are further configured to:
receive a capability communication associated with the repeater indicating that the repeater supports using different carrier frequencies for the secondary cell.

15. The network node of claim 14, wherein the capability communication indicates a range of frequencies supported for using different carrier frequencies for the secondary cell, the range of frequencies including the first carrier frequency and the second carrier frequency.

16. The network node of claim 14, wherein the capability communication indicates a supported transmit power amplification associated with using different carrier frequencies during an analog repeating operation for the secondary cell.

17. The network node of claim 13, wherein the repeater is an analog repeater associated with a coverage area of the secondary cell.

18. The network node of claim 13, wherein the second configuration information is associated with a first coverage area of the secondary cell, wherein the one or more processors are further configured to:
transmit third configuration information, for the UE, indicating a second operating frequency, from the first carrier frequency, the second carrier frequency, or a third carrier frequency, for the secondary cell.

19. The network node of claim 18, wherein the first operating frequency is associated with the first coverage area of the secondary cell, and
wherein the second operating frequency is associated with a second coverage area of the secondary cell.

20. The network node of claim 18, wherein the first operating frequency is associated with a transmitting frequency of the repeater, and
wherein the second operating frequency is associated with another transmitting frequency of another repeater associated with the secondary cell.

21. A method of wireless communication performed by user equipment (UE), comprising:
receiving, from a network node and via a primary cell, first configuration information associated with a secondary cell indicating a first carrier frequency associated with the secondary cell, the first carrier frequency being associated with a first coverage area of the secondary cell;
communicating, via the secondary cell, a first one or more signals using the first carrier frequency;
receiving, from the network node and via the primary cell, second configuration information associated with the secondary cell indicating a second carrier frequency associated with the secondary cell based at least in part on a location of the UE changing from the first coverage area to a second coverage area of the secondary cell; and
communicating, via the secondary cell, a second one or more signals using the second carrier frequency.

22. The method of claim 21, wherein communicating the first one or more signals using the first carrier frequency comprises:
communicating the first one or more signals via a first repeater associated with the secondary cell; and
wherein communicating the second one or more signals using the second carrier frequency comprises:
communicating the second one or more signals via a second repeater associated with the secondary cell.

23. The method of claim 21, wherein the primary cell is associated with a first frequency band, and
wherein the first carrier frequency and the second carrier frequency are associated with a second frequency band.

24. The method of claim 21, wherein the first configuration information and the second configuration information are included in one or more radio resource control communications.

25. The method of claim 21, wherein the first configuration information and the second configuration information are included in a single communication, the method further comprising:
switching from operating using the first carrier frequency to the second carrier frequency based at least in part on detecting that the location of the UE has changed from the first coverage area to the second coverage area.

26. The method of claim 21, wherein receiving the second configuration information comprises:
receiving the second configuration information as part of an activation procedure of a link associated with the second coverage area.
